(19) United States
(12) Patent Application Publication
(10) Pub. No.: US 2026/0330661 A1
(43) Pub. Date: Oct. 22, 2026

(54) DATA PROCESSING DEVICE DETERMINING RELATIONSHIP BETWEEN COORDINATES ON REFERENCE IMAGE AND COORDINATES ON CAPTURED IMAGE USING FEATURE POINT PAIRS

(71) Applicant: BROTHER KOGYO KABUSHIKI KAISHA, Nagoya (JP)

(72) Inventor: Masaya TAKASU, Tokai (JP)

(21) Appl. No.: 19/706,725

(22) Filed: Jun. 12, 2026

Related U.S. Application Data
(63) Continuation of application No. PCT/JP2024/039787, filed on Nov. 8, 2024.

(30) Foreign Application Priority Data
Dec. 19, 2023 (JP) 2023-213712

(51) Int. Cl. G06T 7/33; G06T 7/00; G06T 7/90

(52) U.S. Cl. CPC G06T 7/337; G06T 7/001; G06T 7/90; G06T 2207/10024; G06T 2207/30144

(57) ABSTRACT

The controller obtains first-type feature descriptors of feature points in a reference image and second-type feature descriptors of feature points in a captured image. The controller obtains candidate feature point pairs based on the first-type feature descriptors and the second-type feature descriptors. Each candidate feature point pair includes one feature point in the reference image and one feature point in the captured image. The controller generates combinations each including three candidate feature point pairs. The controller selects combinations satisfying a first condition from the combinations. For each combination, determining whether the first condition is satisfied is based on parameter types based on three feature points included in the combination. The controller determines a relationship between coordinates on the reference image and coordinates on the captured image using the feature point pairs that are candidate feature point pairs in the selected combinations.

### REFERENCE TO RELATED APPLICATIONS

This is a by-pass continuation application of International Application No. PCT/JP 2024/039787 filed on Nov. 8, 2024 which claims priority from Japanese Patent Application No. 2023-213712 filed on Dec. 19, 2023. The entire contents of the International Application and the priority application are incorporated herein by reference.

### TECHNICAL FIELD

The present disclosure relates to alignment among a plurality of images.

### BACKGROUND ART

In various processes, alignment among a plurality of images is performed. A technique for detecting a defect in an image printed on a sheet by an image forming apparatus such as a printer or a copier is known. In this technique, a marker image for positioning is printed on the same sheet together with a job image designated for printing by a user. An image reading member reads a surface of the sheet to generate a read image to be inspected. An inspection member determines a positional relationship between the read image and a reference image based on feature points of the job image, the marker image extracted from the read image, feature points of the job image, and the marker image extracted from the reference image. The inspection member compares the reference image after determination of the positional relationship between the reference image and the read image, and detects, as a defect, an image region in which a difference in pixel values is equal to or greater than a threshold value.

### SUMMARY

Alignment among a plurality of images is difficult and leaves room for improvement.

In view of the foregoing, it is an object of the present disclosure to provide a technique for performing alignment among a plurality of images.

In order to attain the above and other object, the present disclosure provides a non-transitory computer-readable storage medium storing instructions that, when executed by a computer, cause the computer to perform operations including: obtaining a plurality of feature points in a reference image and a plurality of feature points in a captured image; obtaining a plurality of first-type feature descriptors and a plurality of second-type feature descriptors, each of the plurality of first-type feature descriptors being a feature descriptor of a corresponding one of the plurality of feature points in the reference image, each of the plurality of second-type feature descriptors being a feature descriptor of a corresponding one of the plurality of feature points in the captured image; obtaining a plurality of candidate feature point pairs based on the plurality of first-type feature descriptors and the plurality of second-type feature descriptors, each of the plurality of candidate feature point pairs including one of the plurality of feature points in the reference image and one of the plurality of feature points in the captured image; generating a plurality of combinations, each of the plurality of combinations including three candidate feature point pairs selected from the plurality of candidate feature point pairs; selecting one or more combinations satisfying a first condition from the plurality of combinations, wherein, for each of the plurality of combinations, determining whether the first condition is satisfied is based on one or more parameter types selected from a parameter set including: a parameter type that defines a ratio of lengths of two sides of a triangle defined by three feature points included in three candidate feature point pairs included in a corresponding one of the plurality of combinations; a parameter type that defines a length of one side of the triangle; a parameter type that defines one internal angle of the triangle; and a parameter type that defines an angle between a line segment defined by two feature points of the three feature points and an orientation associated with one of the two feature points; selecting, as a plurality of feature point pairs, candidate feature point pairs included in the one or more combinations among the plurality of candidate feature point pairs; and determining a relationship between coordinates on the reference image and coordinates on the captured image using the plurality of feature point pairs.

According to another aspect, the disclosure provides a data processing device. The data processing device includes a controller including one or more processors. The controller is configured to perform: obtaining a plurality of feature points in a reference image and a plurality of feature points in a captured image; obtaining a plurality of first-type feature descriptors and a plurality of second-type feature descriptors, each of the plurality of first-type feature descriptors being a feature descriptor of a corresponding one of the plurality of feature points in the reference image, each of the plurality of second-type feature descriptors being a feature descriptor of a corresponding one of the plurality of feature points in the captured image; obtaining a plurality of candidate feature point pairs based on the plurality of first-type feature descriptors and the plurality of second-type feature descriptors, each of the plurality of candidate feature point pairs including one of the plurality of feature points in the reference image and one of the plurality of feature points in the captured image; generating a plurality of combinations, each of the plurality of combinations including three candidate feature point pairs selected from the plurality of candidate feature point pairs; selecting one or more combinations satisfying a first condition from the plurality of combinations, wherein, for each of the plurality of combinations, determining whether the first condition is satisfied is based on one or more parameter types selected from a parameter set including: a parameter type that defines a ratio of lengths of two sides of a triangle defined by three feature points included in three candidate feature point pairs included in a corresponding one of the plurality of combinations; a parameter type that defines a length of one side of the triangle; a parameter type that defines one internal angle of the triangle; and a parameter type that defines an angle between a line segment defined by two feature points of the three feature points and an orientation associated with one of the two feature points; selecting, as a plurality of feature point pairs, candidate feature point pairs included in the one or more combinations among the plurality of candidate feature point pairs; and determining a relationship between coordinates on the reference image and coordinates on the captured image using the plurality of feature point pairs.

In the above structures, since the candidate feature point pairs included in the one or more combinations, each of which satisfies the first condition, is selected as the plurality of feature point pairs and the relationship between coordinates on the reference image and coordinates on the captured image is determined using the plurality of feature point pairs, the relationship can be determined appropriately.

### BRIEF DESCRIPTION OF DRAWINGS

FIG. 1 is an illustration of a data processing device according to an embodiment.

FIG. 2 is a perspective view illustrating an example of an image capture device.

FIG. 3A is an illustration of an example of an image represented by image data for printing.

FIG. 3B is an illustration of an example of a captured image.

FIG. 4 is a flowchart illustrating an inspection process.

FIG. 5 is a flowchart illustrating an alignment process.

FIG. 6 is a flowchart illustrating a feature point matching process.

FIGS. 7A to 7D are illustrations of examples of images processed in the feature point matching process.

FIG. 8 is a flowchart illustrating a selection process of appropriate candidate feature point pairs using color information.

FIGS. 9A and 9B illustrate how to calculate representative color values.

FIG. 10 is a flowchart illustrating a selection process of candidate feature point pairs to be retained using combinations of a plurality of candidates.

FIG. 11 illustrates a feature point group.

FIGS. 12A and 12B are illustrations of triangles defined by candidate feature point pairs.

FIG. 13 is a flowchart illustrating a process for determination based on an individual combination condition which is included in a combination condition.

FIG. 14 is a flowchart illustrating a process of determining a shape condition.

FIGS. 15A to 15D are diagrams illustrating examples of results of the process shown in FIG. 14.

FIG. 16 illustrates an example of a representation format of a correspondence relationship of coordinates.

FIG. 17A and 17B illustrate examples of difference images.

FIG. 18 is a flowchart illustrating a process of obtaining data of a reference image.

FIG. 19 is a part of a flowchart illustrating a process for determination based on the individual combination condition.

### DESCRIPTION

### A. First Embodiment

### A1. Device Configuration:

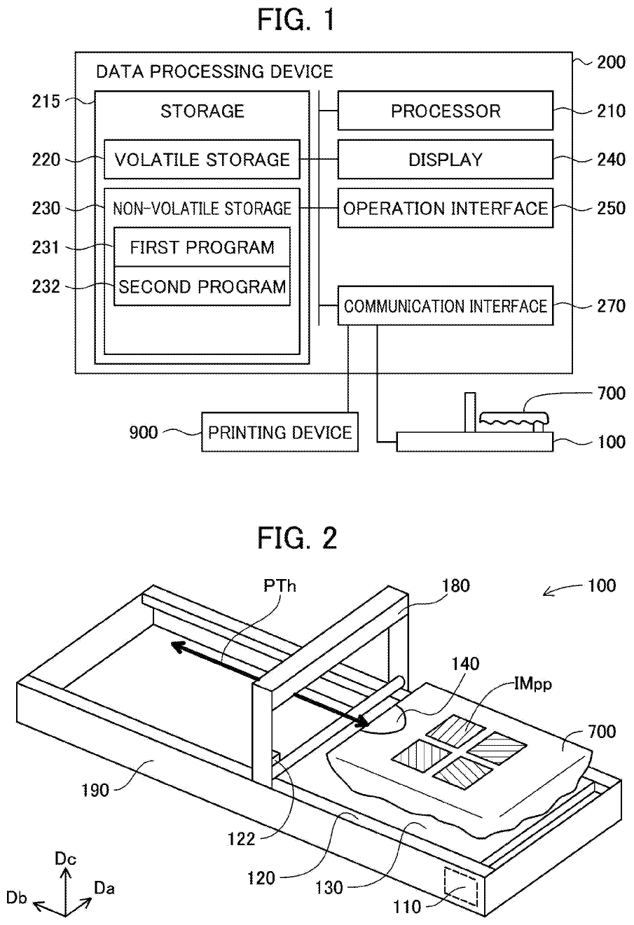

FIG. 1 is an illustration of a data processing device 200 according to an embodiment. The data processing device 200 is a personal computer, for example. The data processing device 200 executes an inspection process of a printed image. The data processing device 200 includes a processor 210, a storage 215, a display 240, an operation interface 250, and a communication interface 270. The processor 210, the storage 215, the display 240, the operation interface 250, and the communication interface 270 are connected to each other via a bus. The storage 215 includes a volatile storage 220 and a non-volatile storage 230.

The processor 210 is configured to perform data processing. The processor 210 is, for example, a Central Processing Unit (CPU) or a System on a Chip (SoC). The volatile storage 220 is, for example, a Dynamic Random Access Memory (DRAM). The non-volatile storage 230 is, for example, a flash memory. The non-volatile storage 230 stores data of a first program 231 and data of a second program 232. The second program 232 is used in another embodiment described later.

The display 240 is a device configured to display an image, such as a liquid crystal display or an organic electroluminescence (EL) display. The operation interface 250 is a device configured to receive an operation by a user, such as buttons, levers, or a touch panel disposed on the display 240. The operation interface 250 may be a user interface. The display 240 and the operation interface 250 may be integrated into a touch screen. The user can input various requests and instructions to the data processing device 200 by operating the operation interface 250.

The communication interface 270 is an interface for communicating with another device (for example, including one or more of a USB interface, a wired LAN interface, a wireless interface compliant with IEEE 802.11, and an industrial camera interface (e.g., CameraLink or CoaXPress)). The communication interface 270 may be a network interface. In the embodiment, an image capture device 100 and a printing device 900 are connected to the communication interface 270. The printing device 900 is an inkjet printing device that prints an image on a print medium such as cloth or paper by ejecting ink onto the print medium. The image capture device 100 generates image data representing a captured image representing a target object by optically reading the target object, that is, optically capturing an image of the target object. In the following description, the print medium is a T-shirt, and the image capture device 100 reads a T-shirt on which an image has been printed. The printing medium may be a garment such as an upper-body garment and a lower-body garment. Examples of the upper-body garment includes a shirt, a T-shirt, a blouse, a jacket, a coat, a sweater, a hoodie, and a vest. Examples of the lower-body garment includes a pant, a trouser, a skirt, and a jean.

FIG. 2 is a perspective view illustrating an example of the image capture device 100. In FIG. 2, a first direction Da and a second direction Db indicate horizontal directions, and a third direction Dc indicates a vertically upward direction. The first direction Da and the second direction Db are perpendicular to each other.

In the embodiment, the image capture device 100 includes a housing 190, a table 130, a support member 140 fixed to an upper surface of the table 130, a conveyance device 120, an image capture sensor 180, and a control device (controller) 110. The control device 110, the conveyance device 120, and the image capture sensor 180 are fixed to the housing 190.

The support member 140 is a plate-shaped member or a platen that defines a flat upper surface for supporting a target object to be read. In the FIG. 2, a T-shirt 700 having a printed image IMpp is placed on the support member 140.

The conveyance device 120 is configured to convey the table 130 along an axis parallel to the second direction Db. A configuration of the conveyance device 120 may be varied. Although not shown, in the embodiment, the conveyance device 120 includes a rail that supports the table 130 so as to be slidable along the axis parallel to the second direction Db, a plurality of pulleys, a belt wound around the plurality of pulleys and having a portion fixed to the table 130, and an electric motor that rotates the pulleys. As the electric motor rotates the pulleys, the table 130 (and thus the support member 140) moves along the axis parallel to the second direction Db. The conveyance device 120 further includes a position sensor 122 (for example, a rotary encoder) that detects a position of the table 130 along a conveyance path.

The image capture sensor 180 is disposed at a position higher than the support member 140 disposed on a conveyance path PTh of the support member 140. The image capture sensor 180 includes a line sensor including a plurality of photoelectric conversion elements arranged in a direction intersecting the conveyance direction Db (in the embodiment, a direction Da perpendicular to the conveyance direction Db). The line sensor may be a Contact Image Sensor (CIS) or a Charge Coupled Device (CCD). The image capture sensor 180 faces downward. The image capture sensor 180 can read a portion of the target object supported by the support member 140, where the portion is located below the image capture sensor 180.

When reading the T-shirt 700, the image capture device 100 conveys the table 130 along the axis parallel to the second direction Db. The image capture sensor 180 repeatedly reads the T-shirt 700 during conveyance. As a result, the image capture sensor 180 can read an entirety of a portion of the T-shirt 700 supported by the support member 140.

The control device 110 is an electric circuit configured to control the conveyance device 120 and the image capture sensor 180. The control device 110 may include a computer or dedicated hardware (such as an Application Specific Integrated Circuit (ASIC)). By controlling the conveyance device 120 and the image capture sensor 180, the control device 110 generates image data of a captured image or a read image.

### A2. Printing Process:

In the embodiment, an image is printed on the T-shirt 700 (FIG. 2). The printing of the image is performed, for example, as part of a T-shirt sales service. The T-shirt sales service may include on-demand printing. A customer places an order for on-demand printing with a service provider. The service provider prints an image on the T-shirt 700 using image data that the customer has supplied in accordance with the order.

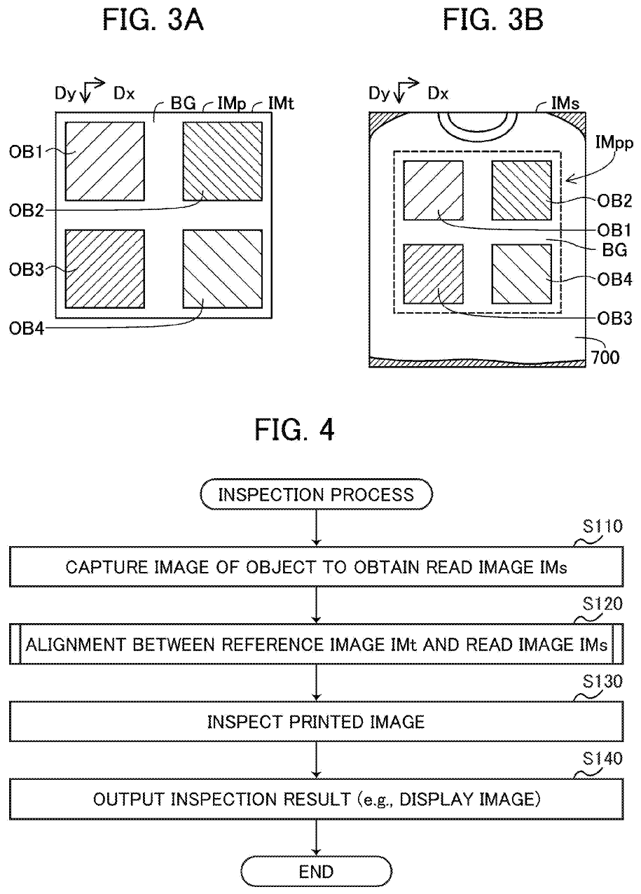

FIG. 3A illustrates an example of an image represented by image data for printing (referred to as a target image IMp). The image data for printing is an example of original image data. In the embodiment, the image data of the target image IMp is bitmap data representing color values of a plurality of pixels arranged in a matrix in a first direction Dx and a second direction Dy. Color values for each pixel may be gradation values of red (R), green (G), and blue (B), with each value ranging from 0 (zero) to 255. In the example of FIG. 3A, the target image IMp includes a background BG and four rectangular objects OB1 to OB4. The objects OB1 to OB4 are represented in mutually different colors. For example, a color of the first object OB1 is red, a color of the second object OB2 is green, a color of the third object OB3 is blue, and a color of the fourth object OB4 is gray. In this manner, the target image IMp may include a plurality of objects having mutually different hues.

Although not shown, printing of the target image IMp is performed using the data processing device 200 and the printing device 900. Alternatively, printing of the target image IMp may be performed using another device.

In printing the target image IMp, various errors may occur. A printed image may have various defects due to such errors. For example, due to an ink ejection abnormality, a portion of the printed image may be missing. The data processing device 200 detects defects in the printed image by an inspection process described later. In the embodiment, the image data of the target image IMp is used in the inspection process. After printing of the target image IMp, the image data of the target image IMp is stored in the storage 215 (for example, the non-volatile storage 230) of the data processing device 200 for the inspection process.

### A3. Inspection Process:

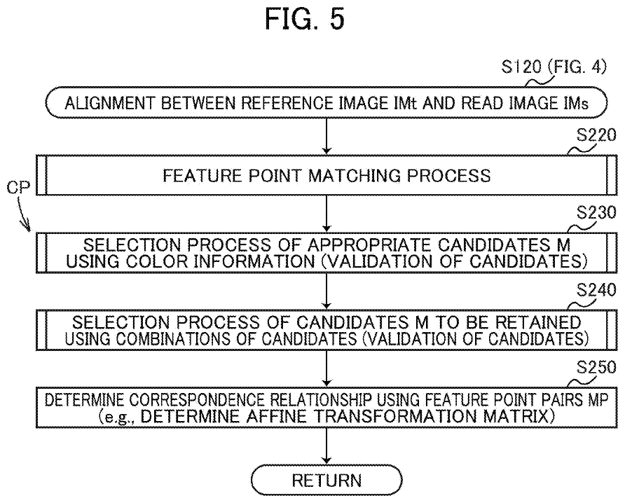

FIG. 4 is a flowchart illustrating an inspection process. For inspection, the T-shirt 700 is placed on the support member 140 of the image capture device 100 (FIG. 2) such that the printed image IMpp can face the image capture sensor 180. In the embodiment, an operator places the T-shirt 700 on the support member 140. Alternatively, a machine (for example, a robot arm) may place the T-shirt 700 on the support member 140. After placement of the T-shirt 700, an instruction to start the inspection process is input to the data processing device 200 (FIG. 1). In the embodiment, the operator inputs the start instruction by operating the operation interface 250. The processor 210 starts the inspection process in response to the start instruction. The start instruction may be input to the data processing device 200 via the communication interface 270 by a device different from the data processing device 200.

The processor 210 of the data processing device 200 executes the inspection process in accordance with the first program 231. In S110, the T-shirt 700 is imaged. The processor 210 supplies a reading instruction to the image capture device 100. In response to the reading instruction, the control device 110 of the image capture device 100 reads the T-shirt 700 by controlling the image capture sensor 180 and the conveyance device 120. The control device 110 generates image data representing a read image (captured image) representing the T-shirt 700. The processor 210 obtains the data of the read image from the control device 110 of the image capture device 100 and stores the data of the read image in the storage 215 (for example, the non-volatile storage 230).

FIG. 3B illustrates an example of the read image. In the embodiment, the data of a read image IMs is bitmap data representing color values of a plurality of pixels arranged in a matrix in a first direction Dx and a second direction Dy. A color values for each pixel may be gradation values of red (R), green (G), and blue (B) with each value ranging from 0 to 255. The read image IMs in FIG. 3B represents a portion of the T-shirt 700 that includes the printed image IMpp. The printed image IMpp is an image obtained by printing the target image IMp (FIG. 3A). The printed image IMpp represents the background BG and the objects OB1 to OB4, similarly to the target image IMp.

In S120 (FIG. 4), the processor 210 performs alignment between the reference image and the read image (an alignment process). In the embodiment, the target image IMp (FIG. 3A) is used as the reference image (hereinafter, the target image IMp is also referred to as a reference image IMt).

The T-shirt 700 may be placed in any orientation relative to the image capture sensor 180. Therefore, between the reference image IMt and the read image IMs, orientations of the objects OB1 to OB4 in the images (that is, rotation angles of the objects) may differ. Further, between the reference image IMt and the read image IMs, a pixel density (also referred to as a resolution) for the same object may differ. That is, a scale of the objects may differ between the reference image IMt and the read image IMs.

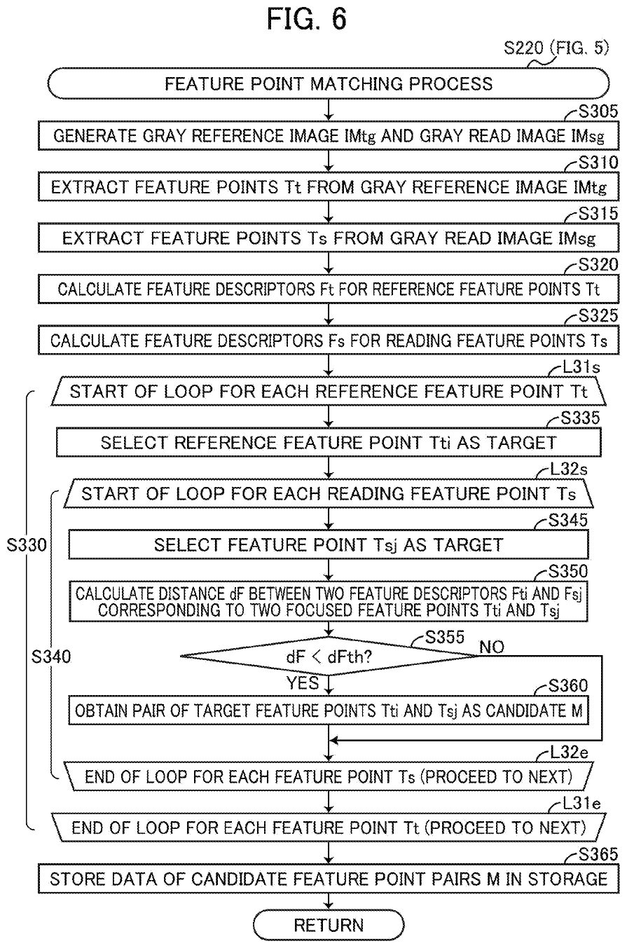

FIG. 5 is a flowchart illustrating the alignment process in S120. In the embodiment, the processor 210 obtains a plurality of pairs of feature points by feature point matching and determines a correspondence relationship between coordinates on the reference image IMt and coordinates on the read image IMs using the plurality of pairs.

In S220, the processor 210 performs a feature point matching process. FIG. 6 is a flowchart illustrating the feature point matching process. In S305, the processor 210 generates a gray reference image IMtg and a gray read image IMsg by performing grayscale conversion on the reference image IMt and the read image IMs. As a correspondence between color gradation values and grayscale gradation values, a known relationship may be adopted, such as the relationship between RGB values in an RGB color space and a luminance value Y in a YCbCr color space.

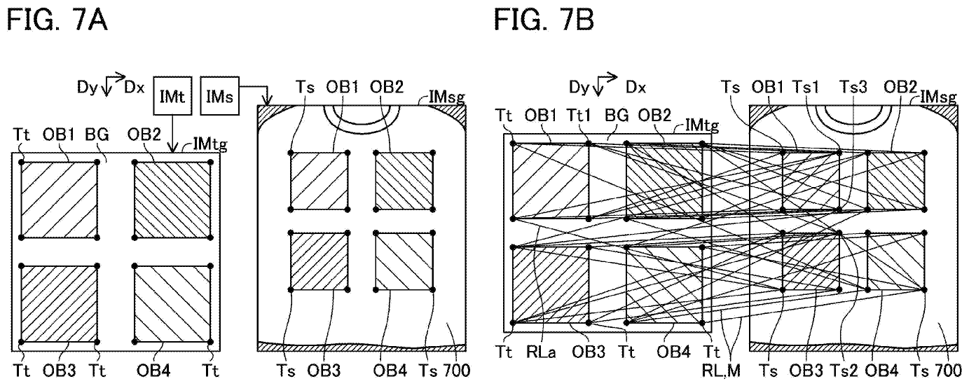

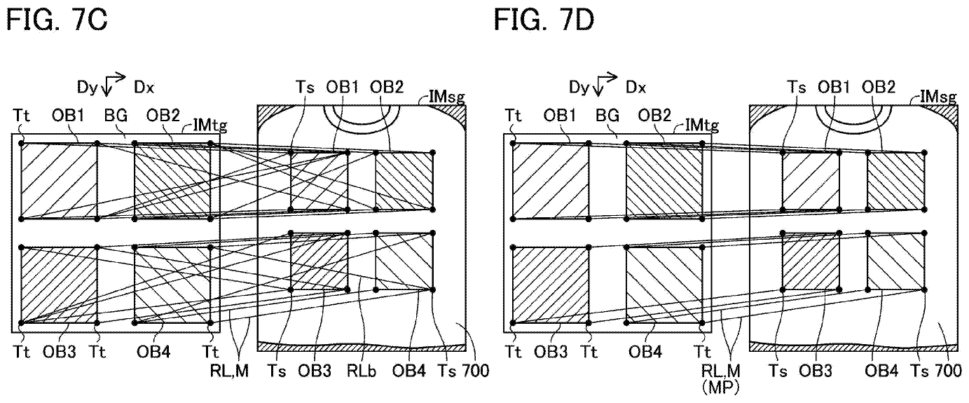

In S310, the processor 210 extracts a plurality of feature points Tt from the gray reference image IMtg. FIGS. 7A to 7D illustrates examples of images processed in feature point matching. FIG. 7A illustrates examples of feature points detected from the images IMtg and IMsg. Each black dot on the gray reference image IMtg indicates a feature point Tt detected from the gray reference image IMtg (also referred to as reference feature points Tt). As illustrated, points indicating characteristic portions such as corners and edges of objects are detected as the feature points Tt. The feature points Tt are also referred to as keypoints. Although not shown, in practice, a larger number of the feature points Tt may be detected (for example, several tens or several hundreds). The reference feature points Tt detected from the gray reference image IMtg correspond to feature points indicating the same portions at the same coordinates on the reference image IMt (FIG. 3A).

A method for detecting feature points may be any of various methods. In the embodiment, a technique called Accelerated-KAZE (A-KAZE), which performs detection of keypoints and calculation of feature descriptors for each keypoint, is used. The A-KAZE technique is disclosed, for example, in the following paper: “Fast Explicit Diffusion for Accelerated Features in Nonlinear Scale Spaces. Pablo F. Alcantarilla, J. Nuevo and Adrien Bartoli. In British Machine Vision Conference (BMVC), Bristol, UK, September 2013.”

The processor 210 detects a plurality of the feature points Tt by analyzing the gray reference image IMtg in accordance with the A-KAZE technique.

In S315 (FIG. 6), the processor 210 extracts a plurality of feature points Ts from the gray read image IMsg. Each black dot on the gray read image IMsg in FIG. 7A indicates a feature point Ts detected from the gray read image IMsg (also referred to as reading feature points Ts). The processor 210 detects the plurality of feature points Ts by analyzing the gray read image IMsg in accordance with the A-KAZE technique. Although not shown, in practice, a larger number of the feature points Ts may be detected (for example, several tens or several hundreds). The reading feature points Ts detected from the gray read image IMsg correspond to feature points indicating the same portions at the same coordinates on the read image IMs (FIG. 3B).

In S320 (FIG. 6), the processor 210 calculates a feature descriptor Ft for each of the plurality of reference feature points Tt. The feature descriptor Ft may be various information describing characteristics of the feature point Tt. The feature descriptor may be data that represents a property of a feature point, and may include, without limitation, a multi-dimensional vector, a scalar value, a bit string, or any data structure composed of a combination of the aforementioned elements. The feature descriptor Ft is calculated, for example, so as to vary depending on a distribution of color values of a plurality of pixels in a vicinity of the feature point Tt. In the embodiment, the processor 210 uses the gray reference image IMtg to calculate an A-KAZE feature descriptor as the feature descriptor Ft. In the A-KAZE technique, the feature descriptor is rotation invariant. To obtain a rotation-invariant feature descriptor, an orientation of the feature point is also calculated. The orientation of the feature point indicates a direction of a luminance (or intensity) gradient within a neighborhood region centered on the feature point (also referred to as a gradient direction or a dominant direction). The processor 210 calculates the feature descriptor Ft and the orientation of the reference feature point Tt.

In S325, the processor 210 calculates a feature descriptor Fs for each of the plurality of reading feature points Ts. In the embodiment, the processor 210 uses the gray read image IMsg to calculate feature descriptors Fs and orientations of the reading feature points Ts in accordance with the A-KAZE technique.

An outline of processing after S325 is as follows. The processor 210 calculates a distance dF between the feature descriptor Ft and the feature descriptor Fs for any combination of the reference feature points Tt and the reading feature points Ts (S350). Then, pairs of the feature points Tt and Ts having the distance dF smaller than a distance threshold dFth are obtained as candidates M of feature point pairs (S355: Yes, S360).

Specifically, the processor 210 executes a loop process S330 (including S335 to S360) between start L31s and end L31e for each of the plurality of reference feature points Tt. In S335, the processor 210 selects an unprocessed reference feature point Tt as a target feature point, that is, a focused feature point Tti. The processor 210 executes a loop process S340 (including S345 to S360) between start L32s and end L32e for each of the plurality of reading feature points Ts. In S345, the processor 210 selects an unprocessed reading feature point Ts as a target feature point, that is, a focused feature point Tsj.

In S350, the processor 210 calculates a distance dF between two feature descriptors Fti and Fsj corresponding to the two focused feature points Tti and Tsj. The distance dF is defined such that a smaller distance dF indicates higher similarity between the two feature descriptors Fti and Fsj. High similarity (i.e., a small distance dF) indicates that the two focused feature points Tti and Tsj represent mutually similar portions (for example, corresponding portions of the same object) in the two images IMtg and IMsg. In the embodiment, the feature descriptors Ft and Fs are A-KAZE feature descriptors represented by binary vectors (each including one or more binary elements). In this case, the processor 210 may calculate a Hamming distance as the distance dF.

In S355, the processor 210 determines whether the distance dF is less than a distance threshold dFth. When the distance dF is small, the feature points Tti and Tsj are likely to represent mutually similar portions (for example, the same portion of the same object) in the images IMt and IMs. When the distance dF is less than the distance threshold dFth (S355: Yes), in S360, the processor 210 obtains a pair of the target feature points Tti and Tsj as a candidate M of a feature point pair (also referred to as a candidate feature point pair M). A feature point pair is a pair of a reference feature point Tt and a reading feature point Ts used for determining a correspondence relationship of coordinates (coordinate correspondence). Feature points Tt and Ts that are associated with each other are also referred to as a matching pair. After S360, the processor 210 ends the loop process S340 for the focused feature point Tsj. When the distance dF is greater than or equal to the distance threshold dFth (S355: No), the processor 210 skips S360 and ends the loop process S340 for the focused feature point Tsj. The processor 210 then repeats the loop process S340 and the loop process S330, thereby executing the processing of S350 to S360 for each combination of the focused feature point Tsj and the focused feature point Tti.

FIG. 7B illustrates an example of candidate feature point pairs M. Each of the plurality of lines RL in the figure indicates a candidate feature point pair M. Each line RL connects feature points Tt and Ts that define a candidate feature point pair M. As illustrated, pairs of feature points Tt and Ts indicating a same portion may be selected as the candidate feature point pairs M. For example, a feature point Tt1 indicating an upper-right corner of the first object OB1 in the gray reference image IMtg may be associated with a feature point Ts1 indicating an upper-right corner of the first object OB1 in the gray read image IMsg.

Pairs of feature points Tt and Ts indicating different portions may also be selected as the candidate feature point pairs M. For example, a feature point Tt1 indicating an upper-right corner of the first object OB1 in the gray reference image IMtg may be associated with a feature point Ts2 indicating an upper-right corner of the third object OB3 in the gray read image IMsg. Each of the rectangular objects OB1 to OB4 has four corners. The corners are locally similar. As a result, a feature point Tt indicating one corner of an object in the gray reference image IMtg may be associated with a feature point Ts indicating another corner of the same object or a corner of another object in the gray read image IMsg. In this manner, when each of the images IMtg and IMsg represents a plurality of locally similar portions, feature points Tt and Ts indicating different portions may be associated with each other.

In the embodiment, as described above, the feature descriptors Ft and Fs are rotation invariant. When the feature descriptors are rotation invariant, similar feature descriptors can be calculated from a same portion of an object regardless of rotation angles of the same object in the images. By using the distance dF between the rotation-invariant feature descriptors Ft and Fs, the processor 210 can associate pairs of feature points indicating a same portion of an object even when the rotation angle of the same object differs between the two images IMtg and IMsg. However, when each of the images IMtg and IMsg represents a plurality of locally similar portions, feature points Tt and Ts indicating different portions may be associated with each other. For example, a feature point Tt1 indicating an upper-right corner of the first object OB1 in the gray reference image IMtg may be associated with a feature point Ts3 indicating a lower-right corner of the first object OB1 in the gray read image IMsg.

As a distance threshold dFth (FIG. 6: S355) increases, a total number of appropriate candidate feature point pairs M may increase. However, a total number of inappropriate candidates M may also increase. As the total number of appropriate candidates M increases, an error in a correspondence relationship of coordinates described later is reduced. When the total number of inappropriate candidates M increases, the error in the correspondence relationship of coordinates may increase. The distance threshold dFth may be determined in advance through experiments such that the error in the correspondence relationship of coordinates is acceptable.

When processing of all combinations of the reference feature points Tt and the reading feature points Ts is completed, in S365, the processor 210 stores data specifying a plurality of candidate feature point pairs M in the storage 215 (for example, the non-volatile storage 230). The processor 210 then ends the processing of FIG. 6, that is, the processing of S220 in FIG. 5.

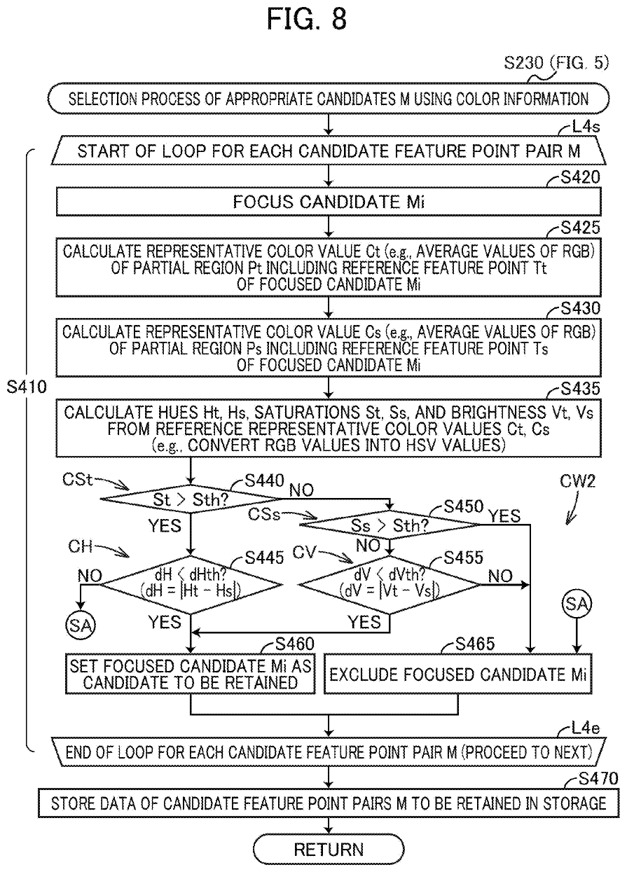

In S230, the processor 210 executes a selection process of appropriate feature point pairs using color information. In the selection process, appropriate candidates M are selected from the plurality of candidate feature point pairs M using color information. That is, the candidate feature point pairs M are validated. FIG. 8 is a flowchart illustrating an example of the selection process in S230 using color information. The processor 210 executes a loop process S410 (including S420 to S465) between start L4s and end L4e for each of the plurality of candidate feature point pairs M.

In S420, the processor 210 selects an unprocessed candidate M as a target candidate, that is, a focused candidate Mi.

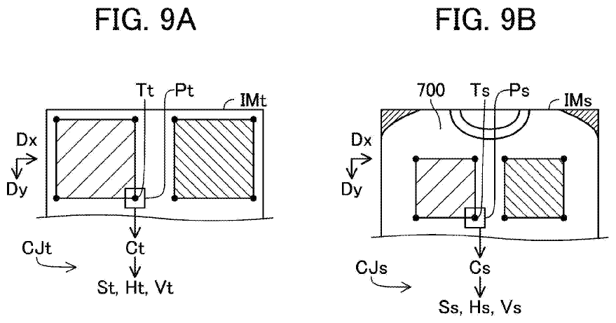

In S425, the processor 210 calculates a representative color value Ct of a first partial region Pt including the reference feature point Tt of the focused candidate Mi. The representative color value Ct is also referred to as a reference representative color value Ct. FIGS. 9A and 9B are diagrams illustrating examples of calculation of representative color values. FIG. 9A shows a portion of the reference image IMt that includes the feature point Tt. As shown in FIG. 9A, the first partial region Pt includes the feature point Tt. The processor 210 calculates the reference representative color value Ct using a plurality of color values of a plurality of pixels in the first partial region Pt. A method for calculating the representative color value Ct may be any of various methods for calculating a color representing the first partial region Pt. In the embodiment, the processor 210 calculates, as gradation values of RGB channels of the representative color value Ct, average values of RGB channels such as mean values of RGB channels within the first partial region Pt. Instead of the mean values, various summary statistics indicating magnitudes of color values (for example, a median or a mode) may be used. A configuration of the first partial region Pt (specifically, a shape of the first partial region Pt and a relative position of the first partial region Pt with respect to a position of the feature point Tt) may be any of various configurations capable of calculating a representative color value Ct representing a color of a portion defined by the feature point Tt. In the embodiment, the first partial region Pt is a region centered on the feature point Tt and is, for example, a region of P×Q pixels arranged in P rows and Q columns. To reduce dependency of the representative color value Ct on a rotation angle of the object, P may be equal to Q (for example, P=Q=5). Instead of a region of P rows and Q columns, the first partial region Pt may be a region in which a distance from the feature point Tt is less than or equal to a distance threshold.

In S430 (FIG. 8), the processor 210 calculates a representative color value Cs of a second partial region Ps including the reading feature point Ts of the focused candidate Mi. The representative color value Cs is also referred to as a reading representative color value Cs. FIG. 9B shows a portion of the read image IMs that includes the feature point Ts. As shown in FIG. 9B, the second partial region Ps includes the feature point Ts. A configuration of the second partial region Ps is the same as that of the first partial region Pt. The second partial region Ps is a region of P×Q pixels arranged in P rows and Q columns centered on the feature point Ts. A method for calculating the reading representative color value Cs is the same as that for the reference representative color value Ct. The processor 210 calculates, as the reading representative color value Cs, average values (mean values) of red (R), green (G), and blue (B) within the second partial region Ps.

In S435 (FIG. 8), the processor 210 calculates a first hue Ht, a first saturation St, and a first brightness Vt from the reference representative color value Ct, and calculates a second hue Hs, a second saturation Ss, and a second brightness Vs from the reading representative color value Cs. As a correspondence relationship between representative color values and hue, saturation, and brightness, a known relationship may be adopted (for example, a correspondence relationship between RGB values in an RGB color space and HSV values in an HSV color space). The set of the first hue Ht, the first saturation St, and the first brightness Vt is an example of the representative color value of the first partial region Pt, similarly to the reference representative color value Ct. The set of the second hue Hs, the second saturation Ss, and the second brightness Vs is an example of the representative color value of the second partial region Ps, similarly to the reading representative color value Cs.

In S440, the processor 210 determines whether a first saturation condition CSt is satisfied. The first saturation condition CSt is a condition that the first saturation St is higher than a saturation threshold Sth. When the first saturation St is higher than the saturation threshold Sth (S440: Yes), in S445, the processor 210 determines whether a hue condition CH is satisfied. The hue condition CH is a condition that an absolute value of a difference between the first hue Ht and the second hue Hs is less than a hue difference threshold dHth. As the absolute value of the difference between the hues Ht and Hs (also referred to as a hue difference dH), a value corresponding to a smaller angular difference between the first hue Ht and the second hue Hs on a hue circle is adopted. When the focused candidate Mi is an appropriate pair of feature points Tt and Ts indicating a same portion, the hue difference dH may be small. When the hue difference dH is less than the hue difference threshold dHth (S445: Yes), in S460, the processor 210 selects (or sets) the focused candidate Mi as a candidate to be retained. When the hue difference dH is greater than or equal to the hue difference threshold dHth (S445: No), the hues may significantly differ between the first partial region Pt and the second partial region Ps. That is, the feature points Tt and Ts of the focused candidate Mi are likely to indicate different portions. In S465, the processor 210 excludes the focused candidate Mi from the candidates of feature point pairs.

As described above, when the first saturation St is higher than the saturation threshold Sth (S440: Yes), the processor 210 excludes, from the candidates, the focused candidate Mi having a hue difference dH greater than or equal to the hue difference threshold dHth. FIG. 7C illustrates an example of candidate feature point pairs M remaining after the processing of FIG. 8. Pairs of feature points Tt and Ts indicating portions having mutually different hues may be excluded. For example, the first object OB1 and the third object OB3 have different hues. A line RLa shown in FIG. 7B indicates a pair of a reference feature point Tt of the first object OB1 and a reading feature point Ts of the third object OB3. As shown in FIG. 7C, the pair indicated by the line RLa is excluded from the candidates of feature point pairs (FIG. 8: S440 (Yes), S445 (No), S465).

When the first saturation St is less than or equal to the saturation threshold Sth (S440: No), in S450, the processor 210 determines whether a second saturation condition CSs is satisfied. The second saturation condition CSs is a condition that the second saturation Ss is higher than the saturation threshold Sth. When the second saturation Ss is higher than the saturation threshold Sth (S450: Yes), the saturations may significantly differ between the first partial region Pt and the second partial region Ps. That is, the feature points Tt and Ts of the focused candidate Mi are likely to indicate different portions. In this case, in S465, the processor 210 excludes the focused candidate Mi from the candidates of feature point pairs.

When the second saturation Ss is less than or equal to the saturation threshold Sth (S450: No), in S455, the processor 210 determines whether a brightness condition CV is satisfied. The brightness condition CV is a condition that an absolute value of a difference between the first brightness Vt and the second brightness Vs is less than a brightness difference threshold dVth. When the focused candidate Mi is an appropriate pair of feature points Tt and Ts indicating a same portion, the absolute value of the difference between the brightnesses Vt and Vs (also referred to as a brightness difference dV) may be small. When the focused candidate Mi is an inappropriate pair of feature points Tt and Ts indicating different portions, the brightness difference dV may be large. Thus, even when the saturations St and Ss are low, the brightnesses Vt and Vs can appropriately represent colors of portions indicated by the feature points Tt and Ts.

When the brightness difference dV is less than the brightness difference threshold dVth (S455: Yes), in S460, the processor 210 selects (or sets) the focused candidate Mi as a candidate to be retained. When the brightness difference dV is greater than or equal to the brightness difference threshold dVth (S455: No), in S465, the processor 210 excludes the focused candidate Mi from the candidate feature point pairs M.

As conditions for retaining the focused candidate Mi become less strict, a total number of appropriate candidates M that remain without being excluded may increase. However, in this case, a total number of inappropriate candidates may also increase. As the total number of appropriate candidates increases, an error in a correspondence relationship of coordinates described later is reduced. When the total number of inappropriate candidates increases, the error in the correspondence relationship of coordinates may increase. Parameters Sth, dHth, and dVth used in S440 to S455 may be determined in advance through experiments such that the error in the correspondence relationship of coordinates is acceptable.

For example, as the hue difference threshold dHth (S445) increases, a condition for retaining the focused candidate Mi becomes less strict. Even when the focused candidate Mi is an appropriate pair of feature points Tt and Ts indicating a portion of a highly saturated color, the hue difference dH may be greater than zero. A hue difference threshold dHth greater than zero allows such a hue difference dH. The hue difference threshold dHth may be set to a value greater than zero and smaller than a maximum possible value of the hue difference dH.

Similarly, as the brightness difference threshold dVth (S455) increases, a condition for retaining the focused candidate Mi becomes less strict. Even when the focused candidate Mi is an appropriate pair of feature points Tt and Ts indicating a portion of a low-saturation color, the brightness difference dV may be greater than zero. A brightness difference threshold dVth greater than zero allows such a brightness difference dV. The brightness difference threshold dVth may be set to a value greater than zero and smaller than a maximum possible value of the brightness difference dV.

When the saturation threshold Sth (S440) is small, a focused candidate Mi having a low first saturation St is processed in S445. Even when the reference representative color value Ct (FIG. 9A) is chromatic, in a case where the first saturation St is low, a hue of a corresponding region in the read image IMs representing the printed image tends to differ from the first hue Ht. That is, when the first saturation St is low, an error in the second hue Hs, and thus an error in the hue difference dH, may increase. When the error in the hue difference dH is large, an appropriate focused candidate Mi may be erroneously excluded (S445: No), and an inappropriate focused candidate Mi may be erroneously retained (S445: Yes). As a result, an error in the correspondence relationship of coordinates may increase. The saturation threshold Sth may be determined in advance through experiments such that an influence of the error in the hue difference dH on the error in the correspondence relationship of coordinates is reduced. The saturation threshold Sth may be set to a value greater than zero and smaller than a maximum possible value of saturation.

After S460 or S465, the processor 210 proceeds to S420 and executes the loop process S410 for a next focused candidate Mi. When the loop process S410 for all candidates M is completed, in S470, the processor 210 stores data specifying candidate feature point pairs M to be retained in the storage 215 (for example, the non-volatile storage 230). The processor 210 then ends the processing of FIG. 8, that is, the processing of S230 in FIG. 5.

In S240, the processor 210 executes a selection process of candidate feature point pairs M to be retained using combinations of a plurality of candidates M. In the selection process, appropriate candidates M are selected from the remaining plurality of candidates M using combinations of the plurality of candidates M. That is, the candidate feature point pairs M are validated in S240.

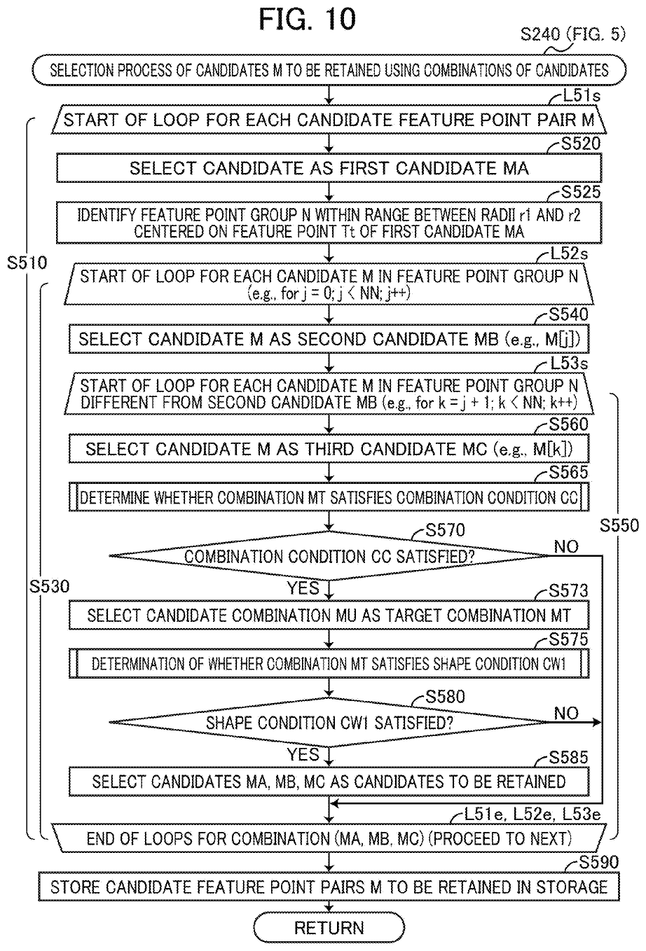

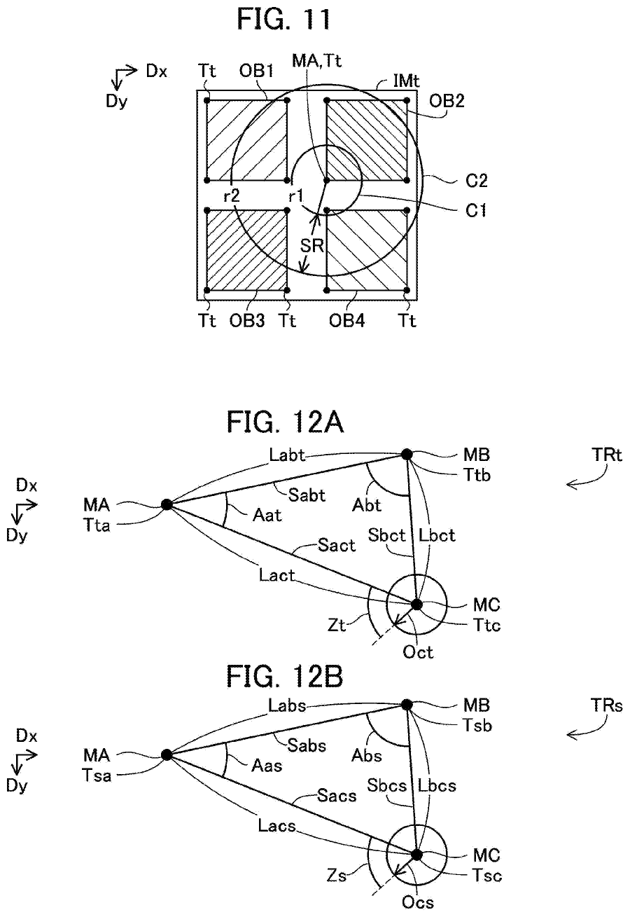

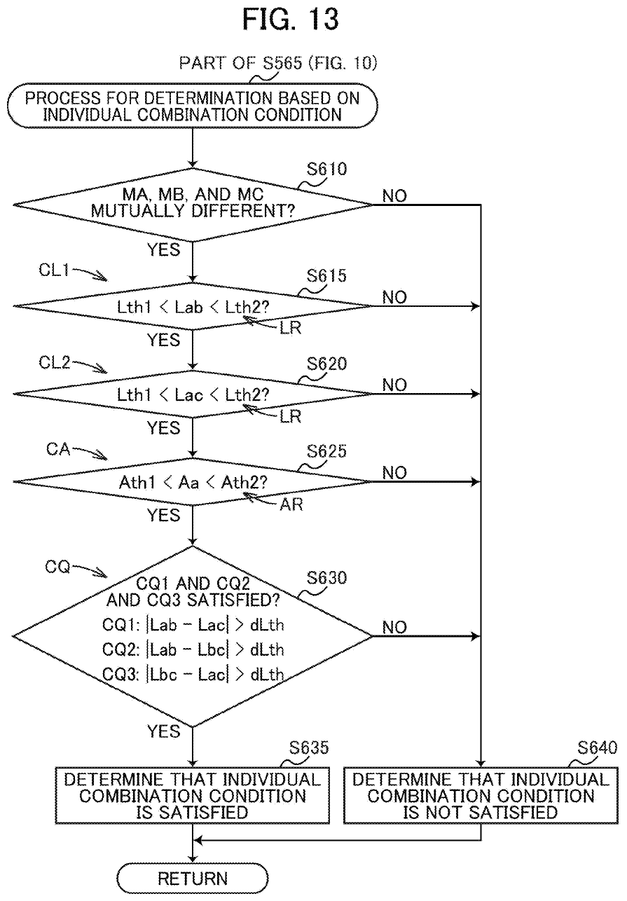

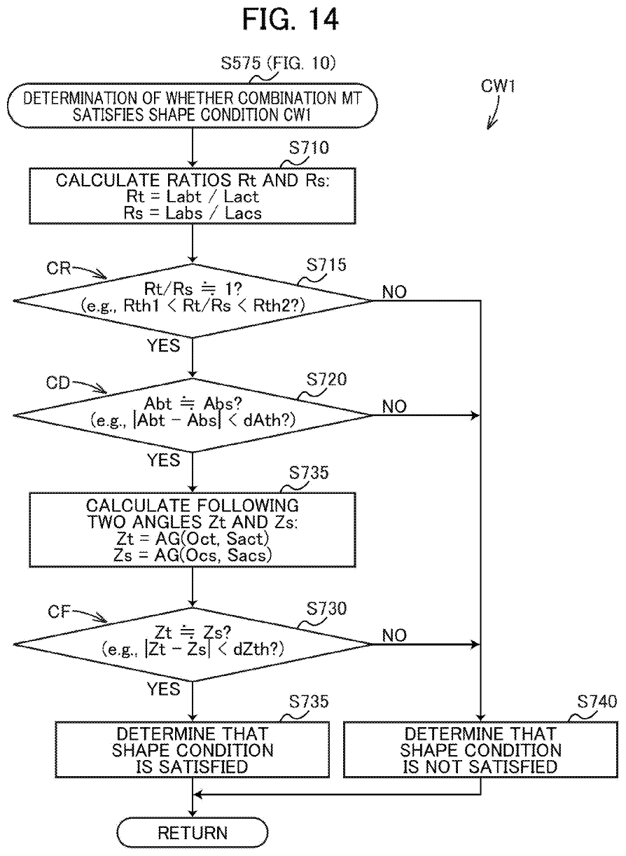

FIG. 10 is a flowchart illustrating an example of the selection process of the candidate feature point pairs M to be retained. An outline of the processing of FIG. 10 is as follows. The processor 210 selects three candidates MA, MB, and MC of feature point pairs (S520 to S560). The second candidate MB and the third candidate MC are selected from a region between a first radius r1 and a second radius r2 centered on a reference feature point Tt of the first candidate MA (details will be described later). Hereinafter, a combination of the selected candidates MA, MB, and MC is also referred to as a candidate combination MU. The processor 210 determines, using the candidate combination MU, whether a combination condition CC is satisfied (S565). When the combination condition CC is satisfied (S570: Yes), the processor 210 selects the candidate combination MU as a target combination MT (S573), and determines, using the target combination MT, whether a shape condition CW1 is satisfied (S575). When the shape condition CW1 is satisfied (S580: Yes), the processor 210 selects (or sets) the three candidates MA, MB, and MC of the target combination MT as candidates to be retained (S585). In the embodiment, a plurality of candidate feature point pairs M remaining through the processing of FIG. 10 are used for determining a correspondence relationship of coordinates.

Specifically, the processor 210 executes a loop process S510 (including S520 to S585) between start L51s and end L51e for each of the plurality of candidate feature point pairs M. In S520, the processor 210 selects an unprocessed candidate M as a first candidate MA.

In S525, the processor 210 classifies feature points Tt within a range between the first radius r1 and the second radius r2 centered on the feature point Tt of the first candidate MA into a feature point group N. FIG. 11 is a diagram illustrating an example of the feature point group N. FIG. 11 shows the reference image IMt and a plurality of reference feature points Tt. One feature point Tt is selected as the first candidate MA. A first circle C1 is a circle having the first radius r1 centered on the feature point Tt of the first candidate MA. A second circle C2 is a circle having the second radius r2 centered on the feature point Tt of the first candidate MA. A selection range SR is a region between the first circle C1 and the second circle C2 (including portions on the first circle C1 and the second circle C2). The processor 210 classifies a plurality of feature points Tt included in the selection range SR into the feature point group N. Hereinafter, a candidate M selected from candidates M each having a feature point Tt in the feature point group N may be simply referred to as the candidate M selected from the feature point group N. In other words, identification of the feature point group N refers to identifying a group of candidates M each having a feature point Tt in the feature point group N.

As will be described later, the processor 210 determines whether to retain a combination of candidates MA, MB, and MC using three reference feature points Tt and three reading feature points Ts corresponding to the three candidates MA, MB, and MC. Specifically, when a condition including that a difference between a shape of a triangle defined by the three reference feature points Tt and a shape of a triangle defined by the three reading feature points Ts is small is satisfied, the processor 210 determines that the combination of the three candidates MA, MB, and MC is retained. When, among three sides of the triangle, a length of any one side is significantly longer or significantly shorter than lengths of the other sides, an error in comparison of the shapes between the two triangles may increase. Candidates MB and MC to be combined with the first candidate MA are selected from the feature point group N. The selection range SR (that is, the radii r1 and r2) is determined in advance through experiments such that a geometric figure suitable for the determination is defined by the combination of the candidates MA, MB, and MC. For example, the first radius r1 may be set to a value equal to or greater than 1% and equal to or less than 20% of a size of the reference image IMt (for example, a length in the first direction Dx or the second direction Dy). The second radius r2 may be set to a value equal to or greater than 30% and equal to or less than 70% of the size of the reference image IMt.

After S525 (FIG. 10), the processor 210 selects a second candidate MB from the feature point group N (S540) and selects a third candidate MC (S560). Specifically, the processor 210 executes a loop process S530 (including S540 to S585) between start L52s and end L52e for each of a plurality of candidates M in the feature point group N. In the loop process S530, the processor 210 selects each of the possible triangles defined by the reference feature point Tt of the first candidate MA and every combination of two reference feature points Tt selected from the feature point group N to determine whether the three candidates MA, MB, and MC corresponding to the possible triangle is retained.

In S540, the processor 210 selects an unprocessed candidate M from the feature point group N as the second candidate MB. Hereinafter, the second candidate MB is assumed to be a j-th candidate in the feature point group N (also expressed as a second candidate MB[j]). An index j is selected, for example, from a range of one or more and less than a total number NN of candidates M in the feature point group N. After S540, the processor 210 executes a loop process S550 (including S560 to S585) between start L53s and end L53e for each of a plurality of candidates M in the feature point group N. In S560, the processor 210 selects an unprocessed candidate M from the feature point group N as the third candidate MC. Hereinafter, the third candidate MC is assumed to be a k-th candidate in the feature point group N (also expressed as a third candidate MC[k]). An index k is selected, for example, from a range of j+1 or more and less than the total number NN of candidates M in the feature point group N. As a result, a candidate M different from the second candidate MB is selected as the third candidate MC. In this manner, the processor 210 selects a combination of the three candidates MA, MB, and MC (that is, a candidate combination MU).

In S565, the processor 210 determines whether the combination condition CC is satisfied using the candidate combination MU. The combination condition CC is a condition for selecting the candidate combination MU as a target combination MT for determining the shape condition CW1 described later. The determination of the combination condition CC is performed using a triangle defined by the candidates MA, MB, and MC of the candidate combination MU.

FIGS. 12A and 12B are diagrams illustrating examples of triangles defined by the candidates MA, MB, and MC. Each of the candidates MA, MB, and MC represents a pair of a reference feature point Tt and a reading feature point Ts. FIG. 12A shows a triangle TRt defined by reference feature points Tta, Ttb, and Ttc of the candidates MA, MB, and MC (referred to as a reference triangle TRt). FIG. 12B shows a triangle TRs defined by reading feature points Tsa, Tsb, and Tsc of the candidates MA, MB, and MC (referred to as a reading triangle TRs). Between the reference triangle TRt and the reading triangle TRs, positions of one or more feature points may differ.

In FIGS. 12 and 12B, reference signs indicate sides of the triangle, lengths of the sides, and magnitudes of internal angles. Reference signs beginning with “S” (for example, Sabt) indicate sides. Two letters following “S” indicate two candidates M connected by the side (a, b, and c respectively indicate the candidates MA, MB, and MC). A suffix “t” or “s” at an end of the reference sign indicates the reference triangle TRt or the reading triangle TRs, respectively. For example, a side Sabt (FIG. 12A) is a side connecting the reference feature point Tta and the reference feature point Ttb of the reference triangle TRt. A reference sign obtained by replacing the initial “S” of the side-indicating sign with “L” indicates a length of the side. For example, a length Labt indicates a length of the side Sabt. Reference signs beginning with “A” (for example, Aat) indicate magnitudes of internal angles of the triangle. A single letter following “A” indicates a candidate M forming a vertex of the internal angle (a, b, and c respectively indicate the candidates MA, MB, and MC). A suffix “t” or “s” at an end of the reference sign indicates the reference triangle TRt or the reading triangle TRs, respectively. For example, an internal angle Aat (FIG. 12A) indicates a magnitude of an internal angle having the reference feature point Tta of the reference triangle TRt as a vertex. In other figures described later, reference signs based on the above rules are also used. In addition, a direction Oct in FIG. 12A indicates an orientation of the feature point Ttc (FIG. 6: S320), and a direction Ocs in FIG. 12B indicates an orientation of the feature point Tsc (FIG. 6: S325).

FIG. 13 is a flowchart illustrating an example of a process for determination based on an individual combination condition which is included in the combination condition CC (FIG. 10: S565). FIG. 13 shows a process for determining whether a single triangle satisfies an individual combination condition. The processor 210 executes the processing of FIG. 13 for each of the reference triangle TRt (FIG. 12A) and the reading triangle TRs (FIG. 12B). When both the reference triangle TRt and the reading triangle TRs satisfy the individual combination condition, the processor 210 determines that the combination condition CC is satisfied. Hereinafter, the processing of FIG. 13 will be described using the reference triangle TRt as an example. In the description of the processing of FIG. 13, reference signs indicating sides, lengths of sides, and magnitudes of internal angles are used with a suffix (t or s) omitted.

In S610, the processor 210 determines whether the three candidates MA, MB, and MC are mutually different. When two or more of the candidates are identical (S610: No), in S640, the processor 210 determines that the individual combination condition is not satisfied and terminates the processing of FIG. 13.

When the three candidates MA, MB, and MC are mutually different (S610: Yes), in S615, the processor 210 determines whether a first length condition CL1 is satisfied. The first length condition CL1 is a condition that a first length Lab is within an allowable length range LR that is greater than a lower limit Lth1 and less than an upper limit Lth2 (the allowable length range LR may also be simply referred to as a length range LR). When the first length Lab is outside the length range LR (S615: No), the processor 210 proceeds to S640. The length range LR (that is, the lower limit Lth1 and the upper limit Lth2) is determined in advance through experiments, similarly to the radii r1 and r2 (FIG. 11) of the selection range SR, such that a shape suitable for the determination is defined by the combination of the three candidates MA, MB, and MC. For example, the lower limit Lth1 may be a value greater than or equal to the first radius r1, and the upper limit Lth2 may be a value less than or equal to the second radius r2.

When the first length Lab is within the length range LR (S615: Yes), in S620, the processor 210 determines whether a second length condition CL2 is satisfied. The second length condition CL2 is a condition that a second length Lac is within the length range LR. When the second length Lac is outside the length range LR (S620: No), the processor 210 proceeds to S640.

When the second length Lac is within the length range LR (S620: Yes), in S625, the processor 210 determines whether a first internal angle condition CA is satisfied. The first internal angle condition CA is a condition that an internal angle Aa is within an allowable internal angle range AR that is greater than a lower limit Ath1 and less than an upper limit Ath2. The allowable internal angle range AR may also be simply referred to as an internal angle range AR. When the internal angle Aa is outside the internal angle range AR (S625: No), the processor 210 proceeds to S640. The internal angle range AR (that is, the lower limit Ath1 and the upper limit Ath2) is determined in advance through experiments, similarly to the radii r1 and r2 (FIG. 11) of the selection range SR, such that a shape suitable for the determination is defined by the combination of the three candidates MA, MB, and MC. For example, the lower limit Ath1 may be a value equal to or greater than 10 degrees and equal to or less than 60 degrees, and the upper limit Ath2 may be a value equal to or greater than 90 degrees and equal to or less than 160 degrees.

When the internal angle Aa is within the internal angle range AR (S625: Yes), in S630, the processor 210 determines whether a scalene condition CQ is satisfied. The scalene condition CQ is a condition that the three sides of the triangle (here, the reference triangle TRt) have mutually different lengths. That is, the scalene condition CQ is a condition that the triangle is a scalene triangle or indicates that a shape of the triangle is different from any of an isosceles triangle, a triangle similar to an isosceles triangle, an equilateral triangle, and a triangle similar to an equilateral triangle.

An isosceles triangle and an equilateral triangle maintain their original shapes even if two sides having a same length are interchanged. Therefore, when the reference triangle TRt is an isosceles triangle or an equilateral triangle, even when two appropriate reading feature points Ts respectively corresponding to two reference feature points Tt are interchanged, a difference between the shape of the reference triangle TRt and a shape of the reading triangle TRs becomes small. Due to this property, when the reference triangle TRt is an isosceles triangle or an equilateral triangle, the corresponding candidates MA, MB, and MC are not suitable for determining a correspondence relationship of coordinates. The same applies when the reference triangle TRt is a triangle similar to an isosceles triangle or a triangle similar to an equilateral triangle.

Accordingly, in the embodiment, when the scalene condition CQ is not satisfied (S630: No), the process proceeds to S640. In S640, the processor 210 determines that the individual combination condition is not satisfied and terminates the processing of FIG. 13. When the scalene condition CQ is satisfied (S630: Yes), in S635, the processor 210 determines that the individual combination condition is satisfied and terminates the processing of FIG. 13.

A specific configuration of the scalene condition CQ may be modified. In the embodiment, the scalene condition CQ is satisfied when all of the following conditions CQ1 to CQ3 are satisfied:
(CQ1) An absolute value of a difference between lengths Lab and Lac is greater than a length difference threshold dLth.
(CQ2) An absolute value of a difference between lengths Lab and Lbc is greater than the length difference threshold dLth.
(CQ3) An absolute value of a difference between lengths Lbc and Lac is greater than the length difference threshold dLth.

Each of the conditions CQ1 to CQ3 indicates that a difference between lengths of two sides is large. The scalene condition CQ defined by the conditions CQ1 to CQ3 indicates that the triangle does not include two sides having a length difference that is equal to or less than the length difference threshold dLth. The length difference threshold dLth is determined in advance through experiments, similarly to the radii r1 and r2 (FIG. 11) of the selection range SR, such that a shape suitable for the determination is defined by the feature points of the combination of the three candidates MA, MB, and MC. For example, the length difference threshold dLth may be a value equal to or greater than 2% and equal to or less than 10% of the upper limit Lth2 referenced in S615 and S620 (FIG. 13). The upper limit Lth2 may be the same as the second radius r2.

In S565 (FIG. 10), the processor 210 executes the processing of FIG. 13 for each of the reference triangle TRt and the reading triangle TRs. When both the reference triangle TRt and the reading triangle TRs satisfy the individual combination condition, the processor 210 determines that the candidate combination MU satisfies the combination condition CC. When one or both of the reference triangle TRt and the reading triangle TRs do not satisfy the individual combination condition, the processor 210 determines that the candidate combination MU does not satisfy the combination condition CC.

In S570, the processor 210 branches the processing according to a determination result of S565. When the combination condition CC is satisfied (S570: Yes), in S573, the processor 210 selects the candidate combination MU as a target combination MT. In S575, the processor 210 determines whether the shape condition CW1 is satisfied using the target combination MT.

FIG. 14 is a flowchart illustrating an example of a process for determination based on the shape condition CW1. When each of the three candidates MA, MB, and MC (FIGS. 12A and 12B) of the target combination MT represents an appropriate pair of feature points Tt and Ts, a shape of the reading triangle TRs is approximately the same as a shape of the reference triangle TRt. Further, when an object in an image rotates, a direction of a feature point (e.g., the direction Oct of the feature point Ttc) rotates together with the object indicated by the feature point. The shape condition CW1 is configured in consideration of the above properties. In the embodiment, it is determined that the shape condition CW1 is satisfied when all of three conditions CR, CD, and CF described later are satisfied.

In S710, the processor 210 calculates ratios of lengths of two sides of the triangles TRt and TRs. Specifically, the processor 210 calculates the following two ratios Rt and Rs:

Rt=Labt/Lact

Rs=Labs/Lacs

The ratios Rt and Rs are invariant with respect to a scale and a rotation of the object in the images IMtg and IMs.

In S715, the processor 210 determines whether a ratio condition CR is satisfied. The ratio condition indicates that the ratio Rt/Rs is close to 1 is satisfied. Since the ratios Rt and Rs are invariant with respect to the scale and rotation of the object in the images IMt and IMs, a determination result of the ratio condition CR is also invariant with respect to the scale and rotation. When the shape of the reading triangle TRs is the same as the shape of the reference triangle TRt, Rt/Rs=1. Even when each of the candidates MA, MB, and MC represents an appropriate pair of feature points Tt and Ts, the ratio Rt/Rs may deviate from 1. The ratio condition CR is configured to allow such a deviation. For example, the ratio condition CR may be satisfied when the ratio Rt/Rs is greater than a lower limit Rth1 and less than an upper limit Rth2 (where Rth1<1<Rth2).

When the ratio condition CR is satisfied (S715: Yes), in S720, the processor 210 determines whether a second internal angle condition CD is satisfied. The second internal angle condition CD indicates that an internal angle Abs of the reading triangle TRs is close to an internal angle Abt of the reference triangle TRt. The internal angles Abt and Abs are invariant with respect to the scale and rotation of the object in the images IMt and IMs. Accordingly, a determination result of the second internal angle condition CD is also invariant with respect to the scale and rotation.

When the shape of the reading triangle TRs is the same as the shape of the reference triangle TRt, the internal angle Abs is equal to the internal angle Abt. Even when each of the candidates MA, MB, and MC represents an appropriate pair of feature points Tt and Ts, the internal angle Abs may deviate from the internal angle Abt. The second internal angle condition CD is configured to allow such a deviation. For example, the second internal angle condition CD may be satisfied when an absolute value of a difference between the internal angle Abs and the internal angle Abt is less than an internal angle difference threshold dAth (where dAth>0).

When the second internal angle condition CD is satisfied (S720: Yes), in S725, the processor 210 calculates angles between an orientation (direction) of a feature point and a side of the triangles TRt and TRs. Specifically, the processor 210 calculates the following two angles Zt and Zs:

Zt=AG(Oct, Sact)

Zs=AG(Ocs, Sacs)

AG is a function that derives an angle between an input orientation and an input side. The orientations Oct and Ocs are orientations of the feature points Ttc and Tsc (FIGS. 12A and 12B). As the directions Oct and Ocs of the feature points Ttc and Tsc, directions calculated for deriving the feature descriptors Ft and Fs (S320 and S325 in FIG. 6) may be used. The angle Zt is an angle between the side Sact and the orientation Oct. The angle Zs is an angle between the side Sacs and the orientation Ocs.

In the embodiment, the orientations Oct and Ocs of the feature points Ttc and Tsc are gradient directions calculated according to the A-KAZE technique. When an object in the images IMtg and IMs rotates, the orientations Oct and Ocs rotate together with the object indicated by the feature points Ttc and Tsc in the images IMtg and IMs. The angles Zt and Zs are invariant with respect to the scale and rotation of the object in the images IMt and IMs.

In S730, the processor 210 determines whether an angle condition CF is satisfied. The angle condition CF indicates that the angle Zs of the reading triangle TRs is close to the angle Zt of the reference triangle TRt. Since the angles Zt and Zs are invariant with respect to the scale and rotation of the object in the images IMtg and IMs, a determination result of the angle condition CF is also invariant with respect to the scale and rotation. When the shape of the reading triangle TRs is the same as the shape of the reference triangle TRt and the feature points Ttc and Tsc indicate a same portion of a same object, the angle Zs is approximately equal to the angle Zt. Even when each of the candidates MA, MB, and MC represents an appropriate pair of feature points Tt and Ts, the angle Zs may deviate from the angle Zt. The angle condition CF is configured to allow such a deviation. For example, the angle condition CF may be satisfied when an absolute value of a difference between the angles Zt and Zs is less than an angle difference threshold dZth (where dZth>0).

When all of the conditions CR, CD, and CF are satisfied (S715: Yes, S720: Yes, and S730: Yes), it is estimated that all of the candidates MA, MB, and MC are appropriate pairs. In this case, in S735, the processor 210 determines that the shape condition CW1 is satisfied, and terminates the processing of FIG. 14.

When one or more of the conditions CR, CD, and CF are not satisfied, it is estimated that at least one of the candidates MA, MB, and MC is an inappropriate pair. When at least one of S715: No, S720: No, and S730: No holds, in S740, the processor 210 determines that the shape condition CW1 is not satisfied, and terminates the processing of FIG. 14.

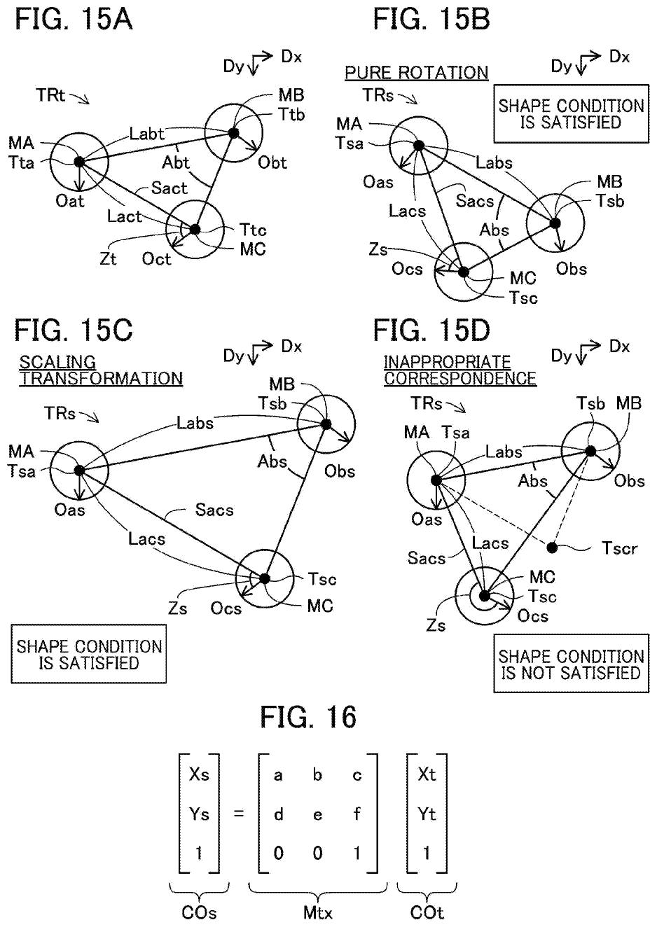

FIGS. 15A to 15D illustrate examples of results of the processing of FIG. 14. FIG. 15A shows an example of the reference triangle TRt, and FIGS. 15B to 15D show examples of reading triangles TRs corresponding to the reference triangle TRt.

FIG. 15B shows a case where the candidates MA, MB, and MC are appropriate, and the scale is the same but the rotation angle differs between the reference image IMt and the read image IMs. In this case, since the rotation-invariant conditions CR, CD, and CF (FIG. 14) are satisfied, the shape condition CW1 is satisfied.

FIG. 15C shows a case where the candidates MA, MB, and MC are appropriate, and the rotation angle is the same but the scale differs between the reference image IMt and the read image IMs. In this case, since the scale-invariant conditions CR, CD, and CF (FIG. 14) are satisfied, the shape condition CW1 is satisfied.

Although not illustrated, even when the candidates MA, MB, and MC are appropriate and both the scale and the rotation angle differ between the reference image IMt and the read image IMs, the shape condition CW1 is satisfied because the conditions CR, CD, and CF (FIG. 14) are satisfied.

FIG. 15D shows a case where the candidates MA and MB are appropriate, but the third candidate MC is inappropriate. Specifically, the feature point Tsc differs from an appropriate feature point Tscr. When the combination of candidates MA, MB, and MC includes an inappropriate candidate M, No determination may made for one or more of the conditions CR, CD, and CF (FIG. 14) (that is, the shape condition CW1 may not be satisfied).

Note that as the conditions CR, CD, and CF (FIG. 14) become less strict, the total number of combinations of appropriate candidates MA, MB, and MC that satisfy the shape condition CW1 may increase. However, the total number of combinations of inappropriate candidates MA, MB, and MC that satisfy the shape condition CW1 may also increase. As the total number of appropriate candidates increases, an error in a correspondence relationship of coordinates described later is reduced. When the total number of inappropriate candidates increases, the error in the correspondence relationship of coordinates may increase. The conditions CR, CD, and CF (in the present embodiment, parameters Rth1, Rth2, dAth, and dZth) may be experimentally determined in advance such that the error in the correspondence relationship of coordinates is within an allowable range. The lower limit Rth1 (S715) may be any of various values less than 1, for example, a value of 0.85 or more and less than 1. The upper limit Rth2 may be any of various values greater than 1, for example, a value greater than 1 and 1.15 or less. The internal angle difference threshold dAth (S720) may be any of various values greater than zero, for example, a value greater than zero and 10 degrees or less. The angle difference threshold dZth (S730) may be any of various values greater than zero, for example, a value greater than zero and 10 degrees or less.

After the processing of FIG. 14, that is, after S575 (FIG. 10), in S580, the processor 210 branches the processing according to the determination result of S575. When the shape condition CW1 is satisfied (S580: Yes), in S585, the processor 210 selects (or sets) the candidates MA, MB, and MC of the target combination MT as candidates to be retained. After S585, the processor 210 terminates the loop process S550 for the current combination of candidates MA, MB, and MC.

When the combination condition CC is not satisfied (S570: No) or when the shape condition CW1 is not satisfied (S580: No), the processor 210 skips S585 and terminates the loop process S550 for the current combination of candidates MA, MB, and MC.

Thereafter, the processor 210 executes the loop process S550 using a next one of a plurality of third candidates MC, the loop process S530 using a next one of a plurality of second candidates MB, and the loop process S510 using a next one of a plurality of first candidates MA. After completion of the repetitions of the loop processes S510, S530, and S550, in S590, the processor 210 stores data representing the candidate feature point pairs M to be retained in the storage 215 (e.g., the non-volatile storage 230). The processor 210 then terminates the processing of FIG. 10, that is, the processing of S240 in FIG. 5.

FIG. 7D illustrates an example of candidate feature point pairs that remain after the processing of FIG. 10. As shown in FIGS. 7C and 7D, inappropriate pairs of feature points Tt and Ts may be excluded without being retained. For example, a line RLb shown in FIG. 7C indicates a pair consisting of a reference feature point Tt at the upper right of the fourth object OB4 and a reading feature point Ts at the lower right of the fourth object OB4. Such a pair, when combined with other pairs, may fail to satisfy the shape condition CW1 and thus be excluded from the candidate feature point pairs (FIG. 10: S580: No). As described with reference to FIGS. 15A to 15D, combinations of candidates MA, MB, and MC that define appropriate reference and reading triangles TRt and TRs may be retained as candidates, whereas combinations that define inappropriate triangles are not retained.

Note that even when a combination of candidates MA, MB, and MC including an appropriate candidate M does not satisfy the shape condition CW1, that appropriate candidate M may satisfy the shape condition CW1 when combined with other appropriate candidates M. Thus, in the processing of FIG. 10, even when No determination is made in S570 or S580, the candidates MA, MB, and MC are not immediately excluded. Through the repeated loop processes S510, S530, and S550, the processor 210 selects (or sets), as a candidate to be retained, candidates M that are selected at least once in S585. The processor 210 excludes candidates M that are not selected even once in S585 through the repeated loop process S510, S530, and S550.

After the processing of FIG. 10, that is, after S240 in FIG. 5, in S250, the processor 210 determines a correspondence relationship between coordinates on the reference image IMt and coordinates on the read image IMs. FIG. 16 illustrates an example of a representation format of the correspondence relationship of coordinates. In the figure, coordinates COt on the reference image IMt, coordinates COs on the read image IMs, and a matrix Mtx that associates these coordinates COt and COs are shown.

In the present embodiment, the matrix Mtx represents a so-called affine transformation. In FIG. 16, the coordinates COt and COs and the matrix Mtx are expressed in a homogeneous coordinate system. The coordinates COt are represented by a three-dimensional vector including a position Xt in a first direction Dx on the image IMt, a position Yt in a second direction Dy on the image IMt, and a third component of 1. Similarly, the coordinates COs are represented by a three-dimensional vector including a position Xs in a first direction Dx on the image IMs, a position Ys in a second direction Dy on the image IMs, and a third component of 1. The matrix Mtx is a 3×3 matrix. As illustrated, the matrix Mtx includes six parameters “a” to “f” arranged in two rows and three columns, and three components (0, 0, 1) in a third row. Such a matrix Mtx can represent rotation, enlargement, reduction, translation, and skew. The matrix Mtx can be calculated using three or more pairs of coordinates COt and COs (that is, three or more feature point pairs).

The processor 210 determines the matrix Mtx (here, six parameters “a” to “f”) using a plurality of feature point pairs MP (that is, the plurality of candidate feature point pairs M remaining after S220-S240 in FIG. 5). The method for determining the matrix Mtx may be any of various methods. For example, the processor 210 may determine the matrix Mtx in accordance with a method called RANdom SAmple Consensus (RANSAC).

In the present embodiment, as described with reference to FIGS. 7A to 7D and FIGS. 15A to 15D, inappropriate candidates for the feature point pairs MP are likely to have been excluded. Accordingly, the processor 210 may calculate the matrix Mtx using all of the remaining feature point pairs MP. The calculation method may be any of various methods (for example, a least squares method). Further, for determining the matrix Mtx, for example, a function of OpenCV (Open Source Computer Vision Library) may be used.

In response to completion of S250 (FIG. 5), the processing of FIG. 5, that is, S120 in FIG. 4, is terminated. In S130, the processor 210 inspects a printed image. The inspection method may be any of various methods using the correspondence relationship of coordinates (FIG. 16). In the present embodiment, the processor 210 generates data of a difference image using the correspondence relationship of coordinates.

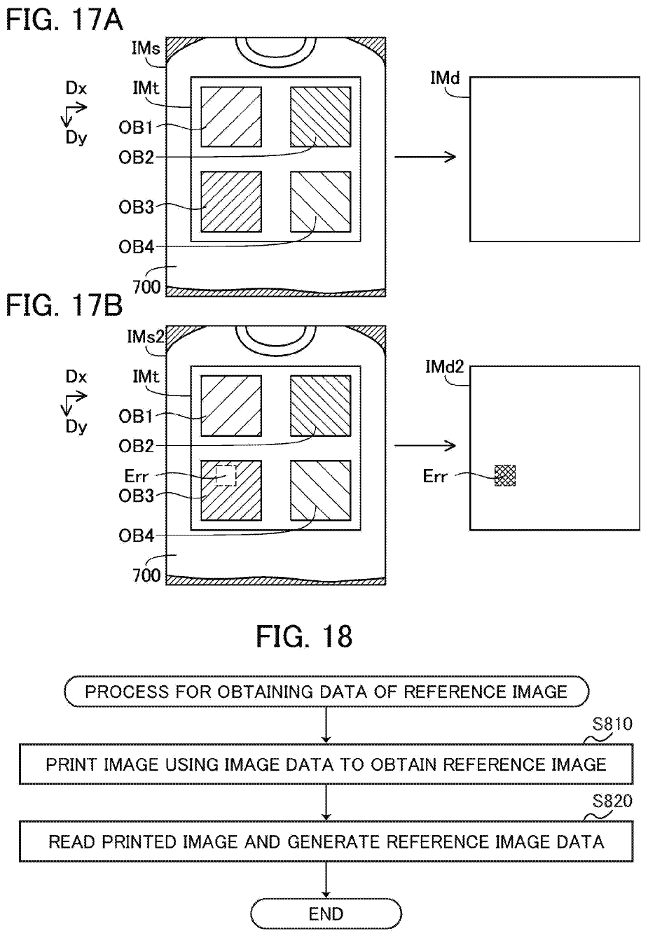

FIGS. 17A and 17B illustrate examples of difference images. FIG. 17A shows a case where the printed image has no defect, and FIG. 17B shows a case where the printed image has a defect (here, a missing portion Err). The left side of each of FIGS. 17A and 17B illustrates a read image IMs or IMs2 and a reference image IMt arranged on the read image IMs or IMs2 according to the correspondence relationship of coordinates. As shown in the right sides of FIGS. 17A and 17B, each of the images IMd and IMd2 illustrates an example of a difference image between the reference image IMt and a corresponding one of the read images IMs and IMs2.

The processor 210 generates data of the difference images IMd and IMd2 representing a difference in color values (for example, an absolute value of a difference in brightness values) between the read image (each of the images IMs and IMs2) and the reference image IMt at positions associated by the correspondence relationship of coordinates. The read image IMs in FIG. 17A represents a printed image without defects. That is, the difference image IMd does not include portions showing large differences. The read image IMs2 in FIG. 17B represents a printed image having a missing portion Err. That is, in the difference image IMd2, a portion corresponding to the missing portion Err shows a larger difference than other portions.

In S140 (FIG. 4), the processor 210 outputs an inspection result. The method of outputting the inspection result may be any of various methods. In the present embodiment, the processor 210 displays the difference image on the display 240 (FIG. 1). By observing the display 240, an operator can easily recognize defects in the printed image.

Alternatively, the processor 210 may output data representing the inspection result to a storage (for example, the non-volatile storage 230 or an external storage connected to the data processing device 200). In this case, the data representing the inspection result is stored in the storage. The data representing the inspection result can be used for various processes (for example, an overall inspection process of the T-shirt 700). After S140, the processor 210 terminates the inspection process.

As described above, in the present embodiment, the processor 210 executes the following processing in accordance with the first program 231. In S355-S360 of FIG. 6, the processor 210 obtains the plurality of candidate feature point pairs M, each being a pair of feature points Ts and Tt, using the feature descriptors Fs corresponding to the feature points Ts and the feature descriptors Ft corresponding to the feature points Tt. The reading feature points Ts are feature points in the gray read image IMsg (FIG. 7), that is, feature points in the read image IMs. The reference feature points Tt are feature points in the gray reference image IMtg, that is, feature points in the reference image IMt.

In the processing of FIG. 5 (including S240), the processor 210 selects, from a plurality of candidate feature point pairs M, a plurality of candidate feature point pairs M satisfying a selection condition CP as a plurality of feature point pairs MP. The selection condition CP includes conditions for selecting the candidate feature point pairs M to be retained in S240. The conditions in S240 include the shape condition CW1 in S575 of FIG. 10. The shape condition CW1 is an example of a first condition for selecting, as three feature point pairs MP, a target combination MT that is a combination of three candidates MA, MB, and MC (hereinafter, the shape condition CW1 may also be referred to as a first condition CW1).

The first condition CW1 includes the conditions CR, CD, and CF shown in FIG. 14. The ratio condition CR (S715) is defined using ratios Rt and Rs. Each of the ratios Rt and Rs is a ratio of lengths of two sides of triangles TRt and TRs defined by the three candidates MA, MB, and MC (FIGS. 12A and 12B). Specifically, the ratio Rt is a ratio of lengths Labt and Lact of two sides Sabt and Sact of the reference triangle TRt. The ratio Rs is a ratio of lengths Labs and Lacs of two sides Sabs and Sacs of the reading triangle TRs.

The second internal angle condition CD (S720) is defined using internal angles Abt and Abs of the triangles TRt and TRs. The angle condition CF (S730) is defined using angles Zt and Zs. The angle Zt (FIG. 12A) is an angle between a side Sact (i.e., a line segment) connecting two reference feature points Tta and Ttc and a direction Oct associated with one feature point Ttc among the two reference feature points Tta and Ttc. The angle Zs (FIG. 12B) is an angle between a side Sacs (i.e., a line segment) connecting two reading feature points Tsa and Tsc and a direction Ocs associated with one feature point Tsc among the two reading feature points Tsa and Tsc.

Thus, in the present embodiment, the first condition CW1 is defined using the ratios Rt and Rs, the internal angles Abt and Abs, and the angles Zt and Zs.

In S250 (FIG. 5), the processor 210 determines a correspondence relationship (in this embodiment, a matrix Mtx) between coordinates COs on the read image IMs and coordinates COt on the reference image IMt, using the plurality of feature point pairs MP (that is, a plurality of remaining candidate feature point pairs M).

As described above, in the present embodiment, a plurality of candidate feature point pairs M satisfying the selection condition CP are selected as a plurality of feature point pairs MP from among a plurality of candidate feature point pairs M. The selection condition CP includes the first condition CW1 for selecting, as N feature point pairs MP, a target combination MT that is a combination of N candidates such as MA, MB, and MC (in this embodiment, N=3). The first condition CW1 is defined using the ratios Rt and Rs, the internal angles Abt and Abs, and the angles Zt and Zs. Accordingly, the processor 210 can appropriately perform alignment between the read image IMs and the reference image IMt.

Further, in the present embodiment, as described in S110 (FIG. 4), the read image IMs is represented by image data generated by optically reading a printed image IMpp. As described with reference to FIG. 3A, the reference image IMt is represented by image data for printing. Accordingly, the processor 210 can appropriately perform alignment between the read image IMs of the printed image IMpp and the reference image IMt represented by the image data for printing.

Further, in the present embodiment, in S240 of FIG. 5, the processor 210 executes the processing of FIG. 10. In the processing of FIG. 10, the processor 210 selects a combination of N candidate feature point pairs M (in this embodiment, N=3) as a target combination MT. Specifically, the processing of FIG. 10 includes S565-S573.

In S565-S573, the processor 210 selects a candidate combination MU, which is a combination of N candidate feature point pairs M, as the target combination MT. In S565 included in S565-S573, the processor 210 performs determination based on the combination condition CC for selecting the candidate combination MU as the target combination MT. The combination condition CC includes the conditions CL1, CL2, and CA shown in FIG. 13.

The first length condition CL1 (S615) and the second length condition CL2 (S620) indicate that lengths Lab and Lac of line segments connecting two feature points of two candidate feature point pairs M included in the candidate combination MU are within the allowable length range LR.

Specifically, in S615, the length Labt (FIG. 12A) and the length Labs (FIG. 12B) are evaluated. The length Labt is a length of a line segment (side Sabt) connecting two reference feature points Tta and Ttb. The length Labs is a length of a line segment (side Sabs) connecting two reading feature points Tsa and Tsb.

In S620, the length Lact (FIG. 12A) and the length Lacs (FIG. 12B) are evaluated. The length Lact is a length of a line segment (side Sact) connecting two reference feature points Tta and Ttc. The length Lacs is a length of a line segment (side Sacs) connecting two reading feature points Tsa and Tsc.

The first internal angle condition CA (S625) indicates that an internal angle Aa of a triangle defined by three feature points of three candidates MA, MB, and MC included in the candidate combination MU is within the allowable internal angle range AR.

Specifically, the internal angle Aat (FIG. 12A) and the internal angle Aas (FIG. 12B) are evaluated. The internal angle Aat is a magnitude of an internal angle of the reference triangle TRt defined by three reference feature points Tta, Ttb, and Ttc. The internal angle Aas is a magnitude of the internal angle of the reading triangle TRs defined by three reading feature points Tsa, Tsb, and Tsc.

As described above, the combination condition CC includes the length conditions CL1 and CL2 for lengths of line segments connecting two feature points, and the internal angle condition CA for an internal angle of a triangle defined by three feature points. Accordingly, the processor 210 can select an appropriate candidate combination MU as a target combination MT.

Further, in the present embodiment, the combination condition CC (FIG. 10: S565) includes the scalene condition CQ (S630) of FIG. 13. The scalene condition CQ indicates that a triangle defined by three feature points of three candidates MA, MB, and MC included in the candidate combination MU does not include two sides having a length difference equal to or less than a length difference threshold dLth.

Specifically, from three sides Sabt, Sact, and Sbct of the reference triangle TRt (FIG. 12A), three pairs of sides are obtained (Sabt-Sact, Sabt-Sbct, Sbct-Sact). When an absolute value of a difference in lengths of sides in each of the three pairs is greater than the length difference threshold dLth, the processor 210 determines that the reference triangle TRt satisfies the scalene condition CQ. The scalene condition CQ is satisfied when the shape of the reference triangle TRt is different from any of an isosceles triangle, a triangle similar to an isosceles triangle, an equilateral triangle, and a triangle similar to an equilateral triangle. The same applies to the reading triangle TRs (FIG. 12B).

As described above, the combination condition CC includes the scalene condition CQ. Accordingly, the processor 210 can reduce a possibility of erroneously selecting an inappropriate candidate combination MU as a target combination MT.

Further, in the present embodiment, the selection condition CP (FIG. 5) further includes conditions for selecting the appropriate candidate feature point pairs M in S230. The conditions in S230 include the conditions CSt, CH, CSs, and CV in S425-S455 shown in FIG. 8. The conditions CSt, CH, CSs, and CV are defined using a saturation St, a hue Ht, and a brightness Vt of a first partial region Pt (FIG. 9A), and a saturation Ss, a hue Hs, and a brightness Vs of a second partial region Ps (FIG. 9B).

The saturation St, the hue Ht, and the brightness Vt are examples of a first representative color value CJt of the first partial region Pt including the feature point Tt in the reference image IMt. The saturation Ss, the hue Hs, and the brightness Vs are examples of a second representative color value CJs of the second partial region Ps including the feature point Ts in the read image IMs. The set of conditions CSt, CH, CSs, and CV is an example of a second condition for selecting the candidate feature point pairs M as feature point pairs MP (hereinafter, the set of conditions CSt, CH, CSs, and CV is referred to as a second condition CW2).

Thus, in the present embodiment, the selection condition CP further includes the second condition CW2 for selecting the candidate feature point pairs M as feature point pairs MP. The second condition CW2 is defined using the first representative color value CJt (including St, Ht, and Vt) of the first partial region Pt including the feature point Tt in the reference image IMt (FIG. 9A), and the second representative color value CJs (including Ss, Hs, and Vs) of the second partial region Ps including the feature point Ts in the read image IMs (FIG. 9B). Accordingly, the processor 210 can select appropriate candidate feature point pairs M as feature point pairs MP.

Further, in the present embodiment, the first representative color value CJt (FIG. 9A) indicates a first saturation St and a first hue Ht, and the second representative color value CJs (FIG. 9B) indicates a second hue Hs. As shown in S440 and S445 of FIG. 8, when the first representative color value CJt indicates a saturation St higher than a saturation threshold Sth (S440: Yes), the processor 210 determines the second condition CW2 using the hue Ht indicated by the first representative color value CJt and the hue Hs indicated by the second representative color value CJs (S445). As described above, when the first saturation St of the first representative color value CJt is higher than the saturation threshold Sth, an error in the second hue Hs of the second representative color value CJs can be small. Accordingly, the processor 210 can appropriately perform determination based on the second condition CW2.

Further, in the present embodiment, the first representative color value CJt (FIG. 9A) indicates the first saturation St and a first brightness Vt, and the second representative color value CJs (FIG. 9B) indicates a second saturation Ss and a second brightness Vs. As shown in S440, S450, and S455 of FIG. 8, when the saturation St of the first representative color value CJt and the saturation Ss of the second representative color value CJs are equal to or less than the saturation threshold Sth (S440: No, S450: No), the processor 210 determines the second condition CW2 using the brightness Vt indicated by the first representative color value CJt and the brightness Vs indicated by the second representative color value CJs (S455). As described above, even when the saturations St and Ss are low, the brightness values Vt and Vs can appropriately represent the color of portions indicated by the feature points Tt and Ts. Accordingly, the processor 210 can appropriately perform determination based on the second condition CW2.

Further, in the present embodiment, as shown in FIG. 5, S240 is executed after S230. In S230 (FIG. 8), the processor 210 selects a plurality of candidate feature point pairs M satisfying the second condition CW2. In S240 (FIG. 10), the processor 210 selects a plurality of candidate feature point pairs M satisfying the first condition CW1 using the plurality of candidate feature point pairs M selected in S230.

As described with reference to FIG. 10, the processor 210 performs determination of the first condition CW1 (S575) for each of a plurality of target combinations MT. When a target combination MT (three candidate feature point pairs M) is selected from p candidate feature point pairs M (where p is an integer of 3 or more), the total number of target combinations MT is expressed by a combination (pC3). The total number of target combinations MT increases rapidly as the total number p of candidate feature point pairs M increases.

In a conceivable case where the process in S240 is executed before S230, the total number of target combinations MT may become large, and the computational load of S240 (determination of the first condition CW1) could increase. In the present embodiment, since the total number of candidate feature point pairs M that can be included in the target combinations MT is reduced by S230, the computational load can be reduced.

### B. Second Embodiment

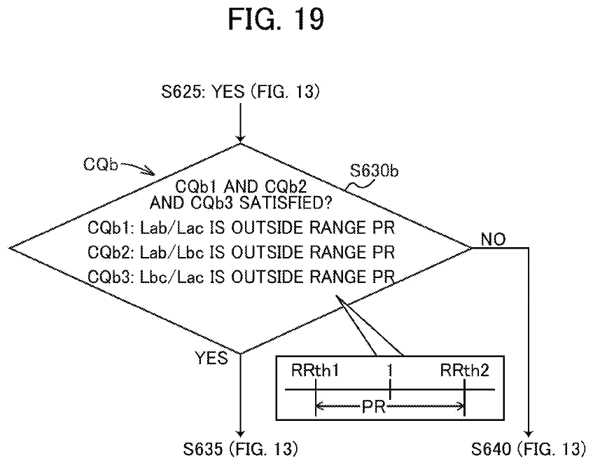

FIG. 18 is a flowchart illustrating an example of a process for obtaining data of a reference image. Unlike the above embodiment, in the present embodiment, image data generated by optically reading an image printed using image data is obtained as the image data of the reference image. This obtaining process may be performed in various cases.

For example, an image on a T-shirt 700 may be printed multiple times using the same image data for printing. In this case, the data of the reference image may be obtained by reading the image printed on the T-shirt 700. Hereinafter, it is assumed that the obtaining process is performed using the data processing device 200, the printing apparatus 900, and the reading apparatus 100 shown in FIG. 1. It is also assumed that the data of the target image IMp (FIG. 3A) is image data for printing (original image data).

In the present embodiment, an operator inputs an instruction to start the obtaining process to the data processing device 200 by operating the operation interface 250. In response to the start instruction, the processor 210 executes the obtaining process according to the second program 232.

In S810, the processor 210 instructs the printing apparatus 900 to print an image on the T-shirt 700 using image data for obtaining a reference image (here, the data of the target image IMp (FIG. 3A)). As shown for the T-shirt 700 in FIG. 2, the target image IMp is printed on the T-shirt 700. Hereinafter, it is assumed that the printed image on the T-shirt 700 has no defects.

The operator may confirm that the printed image has no defects by observing the printed image on the T-shirt 700. In a case where the printed image has defects, the operator may instruct the data processing device 200 to execute S810 again to obtain a defect-free printed image.

In S820, the T-shirt 700 is placed on the support member 140 of the reading apparatus 100 (FIG. 2) such that the printed image can face the image capture sensor 180. In the present embodiment, the operator places the T-shirt 700 on the support member 140. Alternatively, a machine (e.g., a robot arm) may place the T-shirt 700 on the support member 140.

After placing the T-shirt 700, the operator inputs a proceed instruction by operating the operation interface 250. In response to the proceed instruction, the processor 210 supplies a reading instruction to the reading apparatus 100. The control device 110 of the reading apparatus 100 reads the T-shirt 700 in response to the reading instruction. The reading process is performed in the same manner as in S110 of FIG. 4.

The control device 110 generates image data of a read image representing the T-shirt 700, and supplies the generated image data to the data processing device 200. The processor 210 of the data processing device 200 stores the obtained image data of the read image as data of the reference image in the storage 215 (e.g., the non-volatile storage 230). Although not shown, the reference image represents a portion of the T-shirt 700 including the printed image on the T-shirt 700, similarly to the read image IMs shown in FIG. 3B.

The image data of the reference image obtained by the process of FIG. 18 is used in the inspection process of FIG. 4 in place of the image data of the reference image IMt. In this manner, the reference image may be represented by image data generated by optically reading a printed image. Even in this case, the processor 210 can appropriately perform alignment between the read image IMs and the reference image, as in the first embodiment.

The instruction to start the process of FIG. 18 and the proceed instruction in S820 may be input to the data processing device 200 from another device different from the data processing device 200 via the communication interface 270.

### C. Third Embodiment

FIG. 19 is a diagram illustrating another example of the scalene condition (FIG. 13: S630). In this example, a process for determination based on an individual combination condition is executed according to the flowchart shown in FIG. 13 except that S630b shown in FIG. 19 is executed in place of S630 in FIG. 13. In S630b, the processor 210 determines whether a scalene condition CQb is satisfied.

The scalene condition CQb, similarly to the scalene condition CQ (FIG. 13), indicates that the lengths of the three sides of a triangle are different from one another. That is, the scalene condition CQb indicates that the shape of the triangle is different from any of an isosceles triangle, a triangle similar to an isosceles triangle, an equilateral triangle, and a triangle similar to an equilateral triangle.

In the present embodiment, the scalene condition CQb is satisfied when all of the following conditions CQb1 to CQb3 are satisfied:
(CQb1) The ratio Lab/Lac of lengths Lab and Lac is outside a ratio range PR.
(CQb2) The ratio Lab/Lbc of lengths Lab and Lbc is outside the ratio range PR.
(CQb3) The ratio Lbc/Lac of lengths Lbc and Lac is outside the ratio range PR.

Here, the ratio range PR is a range equal to or greater than a lower limit RRth1 and equal to or less than an upper limit RRth2 (where RRth1<1<RRth2).

Each of the conditions CQb1 to CQb3 indicates that the ratio of the lengths of two sides differs from 1. The scalene condition CQb indicates that a triangle (e.g., the reference triangle TRt or the reading triangle TRs) does not include any pair of sides having a length ratio within the ratio range PR including 1.

The lower limit RRth1 and the upper limit RRth2 are experimentally determined in advance, similarly to the radii r1 and r2 (FIG. 11) of the selection range SR, such that a shape suitable for determination is defined by feature points of a combination of three candidates MA, MB, and MC. For example, the lower limit RRth1 may be a value equal to or greater than 0.9 and equal to or less than 0.98, and the upper limit RRth2 may be a value equal to or greater than 1.02 and equal to or less than 1.1.

When the scalene condition CQb is satisfied (S630b: Yes), the processor 210 proceeds to S635 (FIG. 13) and determines that the individual combination condition is satisfied. When the scalene condition CQb is not satisfied (S630b: No), the processor 210 proceeds to S640 and determines that the individual combination condition is not satisfied.

As described above, in the present embodiment, the combination condition CC (FIG. 10: S565) includes the scalene condition CQb (FIG. 19: S630b). Accordingly, similarly to the embodiment of FIG. 13, the processor 210 can reduce the possibility of erroneously selecting an inappropriate candidate combination MU as the target combination MT.

### D. Modifications

(1) The first condition CW1 (FIG. 10: S575) is not limited to the combination of conditions described with reference to FIG. 14, and may be any of various conditions indicating that a target combination MT, which is a combination of N (N is 2 or 3) candidate feature point pairs M, includes appropriate N candidate feature point pairs M.

For example, the image capture device 100 may generate image data of the read image Ims such that a scale of an object is approximately the same between the reference image IMt and the read image IMs. In this case, the first condition CW1 may further include a third length condition that a length of a specific side of a triangle is within an allowable range. The side length may be, for example, lengths Lbct and Lbcs of sides Sbct and Sbcs (FIGS. 12A and 12B).

When the scale is approximately the same between the reference image IMt and the read image IMs, the third length condition can easily exclude a target combination MT including an inappropriate candidate feature point pair M. The allowable range of the third length condition may be experimentally determined in advance, similarly to the allowable length range LR in FIG. 13 (for example, the allowable range of the third length condition may be the same as the allowable length range LR).

In this manner, the first condition CW1 may be defined using the lengths of the sides of a triangle.

Further, the image capture device 100 may be configured such that a rotation angle of an object is approximately the same between the reference image IMt and the read image IMs. In this case, in S320 and S325 of FIG. 6, feature descriptors Ft and Fs that are not rotation-invariant may be calculated (for example, BRIEF (Binary Robust Independent Elementary Features)). In this case, calculation of orientations of the feature points may be omitted, and conditions using the orientations of the feature points (e.g., the angle condition CF shown in FIG. 14) may also be omitted.

The first condition CW1 may be a condition that can be determined using two candidate feature point pairs M (for example, the third length condition). In this case, each of the candidate combination MU and the target combination MT may be a combination of two candidate feature point pairs M.

The first condition CW1 may be defined using one or more of the following four types of parameters: a ratio of lengths of two sides of a triangle defined by three feature points (e.g., ratios Rt and Rs); lengths of sides of the triangle (e.g., lengths Lbct and Lbcs); internal angles of the triangle (e.g., angles Abt and Abs); and an angle between a line segment connecting two feature points and an orientation associated with one of the two feature points (e.g., angles Zt and Zs).
(2) The combination condition CC (FIG. 10: S565) is not limited to have the conditions described with reference to FIGS. 13 and 19, and may be any of various conditions indicating that a combination of N (N is 2 or 3) candidate feature point pairs M forms a shape suitable for determination of the first condition CW1.

For example, the combination condition CC may include a condition that lengths Lbct and Lbcs (FIGS. 12A and 12B) are within the allowable length range LR. The scalene condition CQ (FIG. 13) may include any one or two conditions selected in advance from conditions CQ1 to CQ3. The scalene condition CQb (FIG. 19) may include any one or two conditions selected in advance from conditions CQb1 to CQb3.

The combination condition CC may include any one or more conditions selected in advance from the first length condition CL1, the second length condition CL2, the first internal angle condition CA, the scalene condition CQ, and the scalene condition CQb.

Note that S565 to S570 in FIG. 10 (i.e., determination of the combination condition CC) may be omitted.
(3) The process for selecting appropriate feature point pairs using color information (FIG. 5: S230) is not limited to the process described with reference to FIG. 8, and may be any of various processes.

For example, instead of the processes of S425 and S435, the processor 210 may calculate hues of a plurality of pixels within the first partial region Pt and determine a representative hue of the first partial region Pt using the plurality of hues. The same applies to saturation and brightness. The same also applies to a representative color value of the second partial region Ps.

Further, the second condition CW2 may be any of various conditions using the first representative color value of the first partial region Pt and the second representative color value of the second partial region Ps. For example, the second condition CW2 may be either the hue condition CH or the brightness condition CV.

Preferably, the second condition CW2 indicates that the first representative color value of the first partial region Pt is similar to the second representative color value of the second partial region Ps.
(4) The alignment process is not limited to the process of FIG. 5 and may be any of various processes. For example, S240 may be executed before S230. Further, S230 (i.e., determination of the second condition CW2) may be omitted.
(5) The method for detecting feature points Tt and Ts (i.e., keypoints) is not limited to the methods described in S310 and S315 (FIG. 6), and may be any of various methods for detecting points indicating portions of an object in an image. For example, the detection method may be selected in advance from: detection of extrema (including local and global maxima and minima) using DoG (Difference-of-Gaussian); Harris corner detection; FAST (Features from Accelerated Segment Test) corner detection; SIFT (Scale Invariant Feature Transform); SURF (Speeded Up Robust Features); and ORB (Oriented FAST and Rotated BRIEF).

The method for calculating feature descriptors Ft and Fs (i.e., feature descriptors) is not limited to the methods described in S320 and S325 (FIG. 6), and may be any of various methods for calculating information describing characteristics of keypoints.

For example, the algorithm for calculating feature descriptors may be selected in advance from: BRIEF (Binary Robust Independent Elementary Features); BRISK (Binary Robust Invariant Scalable Keypoints); SIFT (Scale Invariant Feature Transform); SURF (Speeded Up Robust Features); ORB (Oriented FAST and Rotated BRIEF); KAZE; and A-KAZE.

Further, a method for calculating a distance dF between the feature descriptors Ft and Fs may be any of various methods suitable for a data structure of the feature descriptors Ft and Fs. When the feature descriptors Ft and Fs are represented by binary vectors, the distance dF may be a Hamming distance. The distance dF may be, instead of the Hamming distance, various other distances (e.g., norms such as an L1 norm or an L2 norm (also referred to as a Euclidean distance)). Such norms can be applied to various feature descriptors.
(6) Processes other than the process of determining a coordinate correspondence using a plurality of feature points Tt and Ts may be executed according to a program different from the first program 231.

For example, detection of the feature points Tt and Ts and calculation of the feature descriptors Ft and Fs (FIG. 6: S305-S325) may be executed according to another program. Steps S130 and S140 in FIG. 4 may also be executed according to another program.

Further, processes other than the process of determining the coordinate correspondence using a plurality of feature points Tt and Ts may be performed by another apparatus different from the data processing device 200.
(7) The print medium is not limited to the T-shirt 700 and may be various types of clothing (e.g., various shirts such as polo shirts, outerwear, and slacks.). The print medium may be various types of fabric such as clothing and bags. The print medium is not limited to fabric and may be various media such as paper, film, and leather.

Further, the printing apparatus 900 is not limited to an inkjet printing apparatus and may be a printing apparatus of another type (e.g., a laser-type printing apparatus).
(8) The coordinate correspondence (FIG. 16) may represent various transformations such as a homography transformation instead of an affine transformation. Further, the coordinate correspondence may be represented in various formats such as a lookup table instead of the matrix Mtx.

The coordinate correspondence may be used not only for inspection but also for various processes. For example, in a machining process of a metal part, a position and orientation of the metal part relative to a tool may be displaced. In such a case, the position and orientation of the metal part relative to the tool may be determined by analyzing an image of the metal part captured by a digital camera fixed to the tool.

Specifically, the processor 210 may determine a reference position of the metal part in the captured image (and thus the position and orientation of the metal part relative to the tool) by performing alignment between a reference image representing a portion indicating the reference position of the metal part and the captured image. As the alignment process, the processes of the above embodiments (FIG. 5) or the above modifications may be employed.

The read image may be an image representing an object read by a line sensor such as the image capture sensor 180 (FIG. 2), or may be an image representing an object read by an area sensor such as a digital camera. Further, the reference image is not limited to an image related to printing and may be various images (e.g., a pre-prepared image representing a specific portion of an object). In any case, the image may be a grayscale image instead of a color image.
(9) The data processing apparatus for determining the coordinate correspondence is not limited to a personal computer (e.g., the data processing device 200 (FIG. 1)) and may be various other devices (e.g., a smartphone, a tablet computer, and a control device incorporated in an image capture device such as a scanner or a digital camera).

Further, a plurality of devices (e.g., computers) capable of communicating with each other via a network may share portions of the data processing functions of the data processing apparatus, thereby realizing the overall data processing function as a whole (a system including these devices corresponds to the data processing apparatus).

In each of the above embodiments, part or all of a configuration realized by hardware may be replaced with software, and conversely, part or all of a configuration realized by software may be replaced with hardware. For example, the process of S250 in FIG. 5 may be executed by dedicated hardware circuitry such as an Application Specific Integrated Circuit (ASIC).

Further, when part or all of the functions of the present disclosure are implemented by a computer program, the program may be stored in a computer-readable recording medium (e.g., a non-transitory recording medium). The program may be used while being stored in the same or a different recording medium (computer-readable recording medium) as that used at the time of provision.

The “computer-readable recording medium” is not limited to a portable recording medium such as a memory card or a CD-ROM, and may include internal storages in a computer such as various ROMs, as well as external storages connected to a computer such as a hard disk drive.

The term “processor” encompasses both a single processor or a group of multiple processors located either locally or remotely working together or in a distributed fashion to collectively perform the tasks attributed to the “processor” described herein.

While the present disclosure has been described in conjunction with various exemplary embodiments illustrated in the drawings, it will be understood by those of ordinary skill in the art that numerous alternatives, modifications, variations, improvements, and substantial equivalents, whether presently known or later developed, may be made without departing from the spirit and scope of the disclosure. The embodiments and modifications are described for purposes of illustration and to facilitate understanding of the present disclosure, and are not intended to be limiting. Accordingly, the present disclosure encompasses all such alternatives, modifications, variations, improvements, combinations of these, and substantial equivalents. Furthermore, the various embodiments and modifications described may be combined in any suitable manner. Some specific examples of possible alternatives, modifications, and variations have been described; however, these examples are not exhaustive.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A non-transitory computer-readable storage medium storing instructions that, when executed by a computer, cause the computer to perform operations comprising:
obtaining a plurality of feature points in a reference image and a plurality of feature points in a captured image;
obtaining a plurality of first-type feature descriptors and a plurality of second-type feature descriptors, each of the plurality of first-type feature descriptors being a feature descriptor of a corresponding one of the plurality of feature points in the reference image, each of the plurality of second-type feature descriptors being a feature descriptor of a corresponding one of the plurality of feature points in the captured image;
obtaining a plurality of candidate feature point pairs based on the plurality of first-type feature descriptors and the plurality of second-type feature descriptors, each of the plurality of candidate feature point pairs including one of the plurality of feature points in the reference image and one of the plurality of feature points in the captured image;
generating a plurality of combinations, each of the plurality of combinations including three candidate feature point pairs selected from the plurality of candidate feature point pairs;
selecting one or more combinations satisfying a first condition from the plurality of combinations, wherein, for each of the plurality of combinations, determining whether the first condition is satisfied is based on one or more parameter types selected from a parameter set including:
a parameter type that defines a ratio of lengths of two sides of a triangle defined by three feature points included in three candidate feature point pairs included in a corresponding one of the plurality of combinations;
a parameter type that defines a length of one side of the triangle;
a parameter type that defines one internal angle of the triangle; and
a parameter type that defines an angle between a line segment defined by two feature points of the three feature points and an orientation associated with one of the two feature points;
selecting, as a plurality of feature point pairs, candidate feature point pairs included in the one or more combinations among the plurality of candidate feature point pairs; and
determining a relationship between coordinates on the reference image and coordinates on the captured image using the plurality of feature point pairs.

2. The non-transitory computer-readable storage medium according to claim 1,
wherein the reference image is represented by either original image data or image data generated by optically capturing a printed image corresponding to the original image data,
wherein the captured image is represented by image data generated by optically capturing another printed image corresponding to the original image data.

3. The non-transitory computer-readable storage medium according to claim 1,
wherein a set of three candidate feature point pairs included in each of the plurality of combinations satisfies a combination condition,
wherein the combination condition includes one or both of:
a condition that an internal angle of a triangle defined by three feature points included in the set of three candidate feature point pairs is within an allowable angle range; and
a condition that a length of a side of the triangle defined by three feature points included in the set of three candidate feature point pairs is within an allowable length range.

4. The non-transitory computer-readable storage medium according to claim 1,
wherein a set of three candidate feature point pairs included in each of the plurality of combinations satisfies a combination condition,
wherein the combination condition includes one or both of:
a condition that a difference between each two sides of a triangle defined by three feature points included in the set of three candidate feature point pairs is greater than a difference threshold; and
a condition that a ratio of lengths of each two sides of the triangle is outside a ratio range including 1.

5. The non-transitory computer-readable storage medium according to claim 1,
wherein each of the plurality of feature point pairs satisfies a second condition,
wherein for each of the plurality of feature point pairs, determining whether the second condition is satisfied is based on:
a first representative color value of a first partial region in the reference image, the first partial region including a feature point of a corresponding one of the plurality of feature point pairs; and
a second representative color value of a second partial region in the captured image, the second partial region including another feature point of the corresponding one of the plurality of feature point pairs.

6. The non-transitory computer-readable storage medium according to claim 5,
wherein when a saturation value specified by the first representative color value is higher than a saturation threshold, the second condition includes a condition based on a hue value specified by the first representative color value and a hue value specified by the second representative color value.

7. The non-transitory computer-readable storage medium according to claim 5,
wherein when a saturation value specified by the first representative color value is equal to or less than a saturation threshold and a saturation value specified by the second representative color value is equal to or less than the saturation threshold, the second condition includes a condition based on a brightness value specified by the first representative color value and a brightness value specified by the second representative color value.

8. The non-transitory computer-readable storage medium according to claim 5,
wherein all candidate feature point pairs included in each of the plurality of combinations satisfy the second condition.

9. The non-transitory computer-readable storage medium according to claim 1,
wherein the operations further comprise:
generating, based on the relationship, a difference image between the reference image and the captured image; and
outputting the difference image.

10. A data processing device comprising:
a controller including one or more processors, the controller being configured to perform:
obtaining a plurality of feature points in a reference image and a plurality of feature points in a captured image;
obtaining a plurality of first-type feature descriptors and a plurality of second-type feature descriptors, each of the plurality of first-type feature descriptors being a feature descriptor of a corresponding one of the plurality of feature points in the reference image, each of the plurality of second-type feature descriptors being a feature descriptor of a corresponding one of the plurality of feature points in the captured image;
obtaining a plurality of candidate feature point pairs based on the plurality of first-type feature descriptors and the plurality of second-type feature descriptors, each of the plurality of candidate feature point pairs including one of the plurality of feature points in the reference image and one of the plurality of feature points in the captured image;
generating a plurality of combinations, each of the plurality of combinations including three candidate feature point pairs selected from the plurality of candidate feature point pairs;
selecting one or more combinations satisfying a first condition from the plurality of combinations, wherein, for each of the plurality of combinations, determining whether the first condition is satisfied is based on one or more parameter types selected from a parameter set including:
a parameter type that defines a ratio of lengths of two sides of a triangle defined by three feature points included in three candidate feature point pairs included in a corresponding one of the plurality of combinations;
a parameter type that defines a length of one side of the triangle;
a parameter type that defines one internal angle of the triangle; and
a parameter type that defines an angle between a line segment defined by two feature points of the three feature points and an orientation associated with one of the two feature points;
selecting, as a plurality of feature point pairs, candidate feature point pairs included in the one or more combinations among the plurality of candidate feature point pairs; and
determining a relationship between coordinates on the reference image and coordinates on the captured image using the plurality of feature point pairs.
